(19) United States
(12) Patent Application Publication
(10) Pub. No.: US 2026/0192583 A1
(43) Pub. Date: Jul. 9, 2026

(54) RECORDING APPARATUS

(71) Applicant: SEIKO EPSON CORPORATION, TOKYO (JP)

(72) Inventors: Soshi OKAWA, SHIOJIRI-SHI (JP); Tomoya KURASHINA, SHIOJIRI-SHI (JP); Yuichi ARUGA, OKAYA-SHI (JP)

(21) Appl. No.: 19/442,104

(22) Filed: Jan. 7, 2026

(30) Foreign Application Priority Data
Jan. 7, 2025 (JP) 2025-002169

(51) Int. Cl. B41J 25/308; B41J 2/155; B41J 2/165; B41J 11/08; B41J 11/14; B41J 29/00; G01D 5/347

(52) U.S. Cl. CPC B41J 25/308; B41J 2/155; B41J 2/16508; B41J 11/08; B41J 11/14; B41J 29/00; G01D 5/34707; G01D 5/3473; G01D 5/34746

(57) ABSTRACT

A line head includes a first protruding portion and a second protruding portion that protrude toward a facing portion. One of the first protruding portion and the second protruding portion is disposed upstream and the other is disposed downstream with respect to a first intermediate position in a conveyance direction, and one of the first protruding portion and the second protruding portion is disposed in a +X direction with respect to a second intermediate position and the other is disposed in a −X direction with respect to the second intermediate position such that one is disposed on the first intersecting direction of the second intermediate position and the other is disposed on the second intersecting direction in a width direction.

The present application is based on, and claims priority from JP Application Serial Number 2025-002169, filed Jan. 7, 2025, the disclosure of which is hereby incorporated by reference herein in its entirety.

### BACKGROUND

### 1. Technical Field

The present disclosure relates to a recording apparatus that performs recording on a medium.

### 2. Related Art

An inkjet recording apparatus described in JP-A-2007-144633 includes a varying unit that varies a distance between an inkjet head and a platen. During jam detection, the distance between the inkjet head and the platen is increased to facilitate removal of jammed recording paper and prevent the recording paper from rubbing against the head.

JP-A-2007-144633 is an example of the related art.

In a configuration in which the head moves up and down, it is desirable to accurately detect a position of the head in a movement direction and appropriately adjust a gap, which is the distance between the head and the platen.

### SUMMARY

In order to solve the above problems, a recording apparatus according to an aspect of the present disclosure includes: a conveyance path configured to convey a medium in a conveyance direction; a recording unit configured to perform recording on the medium, the recording unit being movable in a direction advancing and retracting with respect to the conveyance path; a facing portion disposed to face the recording unit; a plurality of protruding portions provided in a portion where the recording unit is provided and protruding toward the facing portion; a motor as a power source when moving the recording unit; a moving unit configured to move the recording unit by receiving power from the motor; and a control unit configured to set, as an origin position of the recording unit, a position in a movement direction of the recording unit when the protruding portion is in contact with the facing portion, in which the plurality of protruding portions include a first protruding portion and a second protruding portion, a position where the recording unit performs recording at most upstream in the conveyance direction is defined as a first recording position, a position where the recording unit performs recording on a most downstream in the conveyance direction is defined as a second recording position, and an intermediate position between the first recording position and the second recording position is defined as a first intermediate position, a position where the recording unit performs recording at an endmost portion in a first intersecting direction that is a direction intersecting the conveyance direction is defined as a third recording position, a position where the recording unit performs recording at an endmost portion in a second intersecting direction that is a direction opposite to the first intersecting direction is defined as a fourth recording position, and an intermediate position between the third recording position and the fourth recording position is defined as a second intermediate position, one of the first protruding portion and the second protruding portion is disposed upstream and the other is disposed downstream with respect to the first intermediate position in the conveyance direction, and one of the first protruding portion and the second protruding portion is disposed in the first intersecting direction with respect to the second intermediate position and the other is disposed in the second intersecting direction with respect to the second intermediate position such that one is disposed on the first intersecting direction of the second intermediate position and the other is disposed on the second intersecting direction in a width direction including the first intersecting direction and the second intersecting direction.

In addition, a recording apparatus according to another aspect of the present disclosure includes: a conveyance path configured to convey a medium in a conveyance direction; a recording unit configured to perform recording on the medium, the recording unit being movable in a direction advancing and retracting with respect to the conveyance path; a facing portion disposed to face the recording unit; a plurality of protruding portions provided in a portion where the recording unit is provided and protruding toward the facing portion; a motor as a power source when moving the recording unit; a moving unit configured to move the recording unit by receiving power from the motor; and a control unit configured to set, as an origin position of the recording unit, a position in a movement direction of the recording unit when the protruding portion is in contact with the facing portion, in which the plurality of protruding portions include a first protruding portion and a second protruding portion, a position where the recording unit performs recording at most upstream in the conveyance direction is defined as a first recording position, a position where the recording unit performs recording on a most downstream in the conveyance direction is defined as a second recording position, and an intermediate position between the first recording position and the second recording position is defined as a first intermediate position, a position where the recording unit performs recording at an endmost portion in a first intersecting direction that is a direction intersecting the conveyance direction is defined as a third recording position, a position where the recording unit performs recording at an endmost portion in a second intersecting direction that is a direction opposite to the first intersecting direction is defined as a fourth recording position, and an intermediate position between the third recording position and the fourth recording position is defined as a second intermediate position, the first protruding portion and the second protruding portion are disposed at the first intermediate position in the conveyance direction, and one of the first protruding portion and the second protruding portion is disposed in the first intersecting direction with respect to the second intermediate position and the other is disposed in the second intersecting direction with respect to the second intermediate position such that one is disposed on the first intersecting direction of the second intermediate position and the other is disposed on the second intersecting direction in a width direction including the first intersecting direction and the second intersecting direction.

### BRIEF DESCRIPTION OF THE DRAWINGS

FIG. 1 is a diagram showing an entire medium conveyance path in a printer.

FIG. 2 is a plan view of a head surface of a line head.

FIG. 3 is a perspective view of a cap unit.

FIG. 4 is a block diagram showing a control system related to a movement of the line head.

FIG. 5 is a diagram showing an operation transition of the line head and a shutter.

FIG. 6 is a perspective view of a head unit, a guide frame, and a base frame.

FIG. 7 is a perspective view of the guide frame and the head unit.

FIG. 8 is a perspective view of the head unit and a rotating body.

FIG. 9 is a perspective view of a speed reduction mechanism for transmitting power from a head movement motor to the rotating body.

FIG. 10 is a perspective view of the head unit and a linear encoder.

FIG. 11 is a perspective view of the rotating body.

FIG. 12 is a front view of the rotating body.

FIG. 13 is a perspective view of the rotating body and a rack member.

FIG. 14 is a perspective view of the rotating body and the rack member.

FIG. 15 is a perspective view of the rotating body and the rack member.

FIG. 16 is a perspective view of the rotating body and the rack member.

FIG. 17 is a perspective view of the rotating body and the rack member.

FIG. 18 is a perspective view of the rotating body and the rack member.

FIG. 19 is a cross-sectional view of the head unit and the cap unit.

FIG. 20 is a cross-sectional view of the head unit and the cap unit.

FIG. 21 is a cross-sectional view of the head unit and the cap unit.

FIG. 22A is a chart showing a rotary ENC position, a rotary ENC speed, a linear ENC position, a linear ENC speed, and a motor duty in origin position setting by lowering the line head.

FIG. 22B is a chart showing the rotary ENC position, the rotary ENC speed, the linear ENC position, the linear ENC speed, and the motor duty in lowering the line head.

FIG. 23A is a chart showing a rotary ENC position, a rotary ENC speed, a linear ENC position, a linear ENC speed, and a motor duty in raising the line head.

FIG. 23B is a chart showing the rotary ENC position, the rotary ENC speed, the linear ENC position, the linear ENC speed, and the motor duty in raising the line head.

FIG. 24 is a flowchart showing a flow of processing performed by a control unit.

FIG. 25 is a flowchart showing a flow of processing in origin position setting while raising the line head.

FIG. 26 is a flowchart showing a flow of processing in origin position setting while lowering the line head.

FIG. 27 is a table showing a relationship among a head movement speed, a motor rotation speed, a motor drive load, and a torque limit value in each region of a lever drive region, a cam drive region, and a rack and pinion drive region.

FIG. 28 is a flowchart showing a flow of processing when a power supply is not turned on after being normally turned off.

FIG. 29 is a perspective view of a rotating body and a rack member according to another embodiment.

FIG. 30 is a schematic diagram of the line head and a facing portion for illustrating a problem in the case of performing the origin position setting.

FIG. 31 is a schematic diagram showing an operation of a wiper.

FIG. 32 is a perspective view of a line head viewed from below.

FIG. 33 is a plan view of a head surface of the line head.

FIG. 34 is a diagram of a plate metal and the line head constituting the head unit viewed from a width direction.

FIG. 35 is a development view of the plate metal constituting the head unit.

FIG. 36A is a diagram showing displacement mechanisms that displace movable rollers in a state where the line head is at a recording position.

FIG. 36B is a diagram showing the displacement mechanisms that displace the movable rollers in a state where the line head is between the recording position and a retract position.

FIG. 36C is a diagram showing the displacement mechanisms that displace the movable rollers in a state where the line head is at the retract position.

FIG. 37 is a diagram showing a positional relationship between a protruding portion, a roller, and the facing portion when the protruding portion is provided in an upstream frame or a downstream frame.

FIG. 38 is a diagram showing a positional relationship between the protruding portion, the roller, and the facing portion when the protruding portion is provided in the upstream frame or the downstream frame.

### DESCRIPTION OF EMBODIMENTS

Hereinafter, the present disclosure will schematically be described.

A recording apparatus according to a first aspect includes: a conveyance path configured to convey a medium in a conveyance direction; a recording unit configured to perform recording on the medium, the recording unit being movable in a direction advancing and retracting with respect to the conveyance path; a facing portion disposed to face the recording unit; a plurality of protruding portions provided in a portion where the recording unit is provided and protruding toward the facing portion; a motor as a power source when moving the recording unit; a moving unit configured to move the recording unit by receiving power from the motor; and a control unit configured to set, as an origin position of the recording unit, a position in a movement direction of the recording unit when the protruding portion is in contact with the facing portion, in which the plurality of protruding portions include a first protruding portion and a second protruding portion, a position where the recording unit performs recording at most upstream in the conveyance direction is defined as a first recording position, a position where the recording unit performs recording on a most downstream in the conveyance direction is defined as a second recording position, and an intermediate position between the first recording position and the second recording position is defined as a first intermediate position, a position where the recording unit performs recording at an endmost portion in a first intersecting direction that is a direction intersecting the conveyance direction is defined as a third recording position, a position where the recording unit performs recording at an endmost portion in a second intersecting direction that is a direction opposite to the first intersecting direction is defined as a fourth recording position, and an intermediate position between the third recording position and the fourth recording position is defined as a second intermediate position, one of the first protruding portion and the second protruding portion is disposed upstream and the other is disposed downstream with respect to the first intermediate position in the conveyance direction, and one of the first protruding portion and the second protruding portion is disposed in the first intersecting direction with respect to the second intermediate position and the other is disposed in the second intersecting direction with respect to the second intermediate position such that one is disposed on the first intersecting direction of the second intermediate position and the other is disposed on the second intersecting direction in a width direction including the first intersecting direction and the second intersecting direction.

In a configuration in which a position in the movement direction of the recording unit when the protruding portion is in contact with the facing portion is set as the origin position of the recording unit, there is a concern that a gap between the recording unit and the facing portion cannot be appropriately set depending on a position of the protruding portion. Hereinafter, the gap is referred to as a platen gap for convenience. Note that, an example in which the platen gap cannot be appropriately set depending on the position of the protruding portion will be described later.

According to this aspect, since one of the first protruding portion and the second protruding portion is disposed upstream and the other is disposed downstream with respect to the first intermediate position in the conveyance direction, and one of the first protruding portion and the second protruding portion is disposed in the first intersecting direction with respect to the second intermediate position and the other is disposed in the second intersecting direction with respect to the second intermediate position such that one is disposed on the first intersecting direction of the second intermediate position and the other is disposed on the second intersecting direction in the width direction including the first intersecting direction and the second intersecting direction, a height of the recording unit can be prevented from being inappropriate when the first protruding portion and the second protruding portion are in contact with the facing portion, and thus the platen gap can be appropriately set. Note that, this will also be described in detail later.

A recording apparatus according to a second aspect includes: a conveyance path configured to convey a medium in a conveyance direction; a recording unit configured to perform recording on the medium, the recording unit being movable in a direction advancing and retracting with respect to the conveyance path; a facing portion disposed to face the recording unit; a plurality of protruding portions provided in a portion where the recording unit is provided and protruding toward the facing portion; a motor as a power source when moving the recording unit; a moving unit configured to move the recording unit by receiving power from the motor; and a control unit configured to set, as an origin position of the recording unit, a position in a movement direction of the recording unit when the protruding portion is in contact with the facing portion, in which the plurality of protruding portions include a first protruding portion and a second protruding portion, a position where the recording unit performs recording at most upstream in the conveyance direction is defined as a first recording position, a position where the recording unit performs recording on a most downstream in the conveyance direction is defined as a second recording position, and an intermediate position between the first recording position and the second recording position is defined as a first intermediate position, a position where the recording unit performs recording at an endmost portion in a first intersecting direction that is a direction intersecting the conveyance direction is defined as a third recording position, a position where the recording unit performs recording at an endmost portion in a second intersecting direction that is a direction opposite to the first intersecting direction is defined as a fourth recording position, and an intermediate position between the third recording position and the fourth recording position is defined as a second intermediate position, the first protruding portion and the second protruding portion are disposed at the first intermediate position in the conveyance direction, and one of the first protruding portion and the second protruding portion is disposed in the first intersecting direction with respect to the second intermediate position and the other is disposed in the second intersecting direction with respect to the second intermediate position such that one is disposed on the first intersecting direction of the second intermediate position and the other is disposed on the second intersecting direction in a width direction including the first intersecting direction and the second intersecting direction.

In a configuration in which a position in the movement direction of the recording unit when the protruding portion is in contact with the facing portion is set as the origin position of the recording unit, there is a concern that a gap between the recording unit and the facing portion cannot be appropriately set depending on a position of the protruding portion.

According to this aspect, since the first protruding portion and the second protruding portion are disposed at the first intermediate position in the conveyance direction, and one of the first protruding portion and the second protruding portion is disposed in the first intersecting direction with respect to the second intermediate position and the other is disposed in the second intersecting direction with respect to the second intermediate position such that one is disposed on the first intersecting direction of the second intermediate position and the other is disposed on the second intersecting direction in the width direction, a height of the recording unit can be prevented from being inappropriate when the first protruding portion and the second protruding portion are in contact with the facing portion, and thus the platen gap can be appropriately set. Note that, this will also be described in detail later.

A third aspect is an aspect according to the first or second aspect, in which a distance between the third recording position or the fourth recording position and the second intermediate position in the width direction is defined as a first distance, and the first protruding portion and the second protruding portion are at a position away from the second intermediate position by ½ or more of the first distance.

According to this aspect, since the first protruding portion and the second protruding portion are at the position away from the second intermediate position by ½ or more of the first distance, a posture of the recording unit when the first protruding portion and the second protruding portion are in contact with the facing portion is easily stabilized in the width direction. Accordingly, the platen gap can be appropriately set.

A fourth aspect is an aspect according to the first or second aspect, and the recording apparatus further includes: a maintenance unit configured to perform maintenance on the recording unit, in which the first protruding portion and the second protruding portion are at positions where the maintenance unit is not interfered with when the maintenance unit performs maintenance on the recording unit.

According to this aspect, since the first protruding portion and the second protruding portion are at the positions where the maintenance unit is not interfered with when the maintenance unit performs maintenance on the recording unit, the maintenance unit can appropriately perform the maintenance on the recording unit.

Note that, this aspect is not necessarily an aspect according to the first or second aspect, and may be an aspect according to the third aspect.

A fifth aspect is an aspect according to the first or second aspect, and the recording apparatus further includes: a maintenance unit configured to perform maintenance on the recording unit, in which at least one of the first protruding portion and the second protruding portion is movable to a position where the maintenance unit is not interfered with when the maintenance unit performs maintenance on the recording unit.

According to this aspect, since at least one of the first protruding portion and the second protruding portion is movable to the position where the maintenance unit is not interfered with when the maintenance unit performs maintenance on the recording unit, the maintenance unit can appropriately perform the maintenance on the recording unit.

Note that, this aspect is not necessarily an aspect according to the first or second aspect, and may be an aspect according to the third aspect.

A sixth aspect is an aspect according to the first or second aspect, in which the recording unit has a head surface facing the facing portion, and at least a part of the first protruding portion and at least a part of the second protruding portion are within a region of the head surface in the width direction.

According to this aspect, since at least a part of the first protruding portion and at least a part of the second protruding portion are within the region of the head surface in the width direction, the first protruding portion and the second protruding portion come into contact with the facing portion at a position close to the head surface. Accordingly, the platen gap can be appropriately set.

Note that, this aspect is not necessarily an aspect according to the first or second aspect, and may be an aspect according to any one of the third to fifth aspects.

A seventh aspect is an aspect according to the first or second aspect, in which the recording unit includes a head surface facing the facing portion, a contact roller protruding from the head surface to the facing portion and configured to prevent contact of the medium with the head surface, and a holding member configured to hold the contact roller, and the first protruding portion and the second protruding portion are provided on the holding member.

According to this aspect, since the recording unit includes the contact roller protruding from the head surface to the facing portion and configured to prevent the medium from contacting the head surface, the medium can be prevented from coming into contact with the head surface and being contaminated.

In addition, since the first protruding portion and the second protruding portion are provided on the holding member, a dedicated member for providing the first protruding portion and the second protruding portion is not required, and an increase in cost of the apparatus can be prevented.

Note that, this aspect is not necessarily an aspect according to the first or second aspect, and may be an aspect according to any one of the third to sixth aspects.

An eighth aspect is an aspect according to the first or second aspect, and the recording apparatus further includes: a position detection unit configured to detect a position of the recording unit in the movement direction, in which the control unit sets the origin position based on the position detection unit indicating that the recording unit has no position change during driving of the motor

According to this aspect, since the control unit sets the origin position based on position detection unit indicating that the recording unit has no position change during the driving of the motor, the origin position can be appropriately set.

Note that, this aspect is not necessarily an aspect according to the first or second aspect, and may be an aspect according to any one of the third to seventh aspects.

A ninth aspect is an aspect according to the eighth aspect, in which the position detection unit detects the position of the recording unit between the first protruding portion and the second protruding portion in the width direction.

According to this aspect, since the position detection unit detects the position of the recording unit between the first protruding portion and the second protruding portion in the width direction, the position detection unit is less likely to be influenced by the posture of the recording unit in the width direction when detecting the position of the recording unit, and the position of the recording unit can be appropriately detected.

A tenth aspect is an aspect according to the ninth aspect, in which a distance between the third recording position or the fourth recording position and the second intermediate position in the width direction is defined as a first distance, and the position detection unit detects the position of the recording unit at a position away from the second intermediate position in the width direction by less than ½ of the first distance.

According to this aspect, since the position detection unit detects the position of the recording unit at the position away from the second intermediate position in the width direction by less than ½ of the first distance, the position detection unit is further less likely to be influenced by the posture of the recording unit in the width direction when detecting the position of the recording unit, and the position of the recording unit can be more appropriately detected.

An eleventh aspect is an aspect according to the first or second aspect, and the recording apparatus further includes: a position detection unit configured to detect a position of the recording unit in the movement direction; and a rotation detection unit configured to detect rotation of the motor, in which the position detection unit is a linear encoder including a linear scale provided along the movement direction of the recording unit, and a first detection unit that is a detection unit provided in the recording unit and that detects the linear scale, the rotation detection unit is a rotary encoder including a rotary scale that rotates with the rotation of the motor, and a second detection unit that detects the rotary scale, the moving unit includes a speed reduction mechanism having a speed reduction ratio larger than 1 when the power is transmitted from the motor to the recording unit, and the control unit grasps the position of the recording unit in the movement direction based on a signal from the linear encoder and controls the motor based on a signal from the rotary encoder.

According to this aspect, since the position detection unit is a linear encoder including the linear scale provided along the movement direction of the recording unit and the first detection unit that is a detection unit provided in the recording unit and that detects the linear scale, and is configured to directly detect the movement of the recording unit, the position of the recording unit can be appropriately grasped. As a result, it is easy to appropriately adjust the gap between the recording unit and the facing portion.

Here, since the linear encoder is configured to directly detect the movement of the recording unit, stop accuracy in stopping the motor cannot be obtained due to a resolution of the linear encoder, and there is a concern that the recording unit cannot be accurately stopped at a desired position. However, in this aspect, the moving unit includes the speed reduction mechanism having a speed reduction ratio larger than 1 when the power is transmitted from the motor to the recording unit. The rotation detection unit is a rotary encoder including the rotary scale that rotates with the rotation of the motor and the second detection unit that detects the rotary scale. Therefore, a resolution of the rotary encoder can be ensured. In addition, since the motor is controlled based on the signal from the rotary encoder, the stop accuracy in stopping the motor can be improved, and it is easy to accurately stop the recording unit at a desired position.

Note that, the resolution here means the number of output edges (low to high transition of a waveform) of an encoder with respect to the unit operation amount, in other words, means a movement amount of the recording unit per edge. In addition, a high resolution means that the number of output edges is large with respect to the unit operation amount, in other words, means that the movement amount of the recording unit per edge is small.

Note that, this aspect is not necessarily an aspect according to the first or second aspect, and may be an aspect according to any one of the third to tenth aspects.

Hereinafter, the present disclosure will be specifically described.

An inkjet printer 1 is described below as an example of a recording apparatus that performs recording on a medium. The inkjet printer 1 is hereinafter simply referred to as a printer 1.

Note that, an X-Y-Z coordinate system shown in each figure is an orthogonal coordinate system in which a direction indicated by an arrow is a positive (+) direction and a direction opposite to the positive (+) direction is a negative (31 ) direction. An X-axis direction is an apparatus width direction and is a width direction of the medium on which recording is performed. When viewed from an operator of the printer 1, a +X direction is the left side and a −X direction is the right side. Hereinafter, the X-axis direction is sometimes referred to as a medium width direction or simply referred to as a width direction.

A Y-axis direction is an apparatus depth direction and is a direction along a medium conveyance direction during recording. A +Y direction is a direction from a back to a front of the apparatus and a −Y direction is a direction from the front to the back of the apparatus. In the embodiment, among side surfaces constituting the periphery of the printer 1, a side surface in the +Y direction is an apparatus front surface and a side surface in the −Y direction is an apparatus back surface.

A Z-axis direction is a direction along a vertical direction and is an apparatus height direction. A +Z direction is a vertically upward direction, and a −Z direction is a vertically downward direction.

Note that, in the following, a direction in which a medium is conveyed is sometimes referred to as “downstream” and a direction opposite to the direction is sometimes referred as “upstream”.

### Medium Conveyance Path in Printer

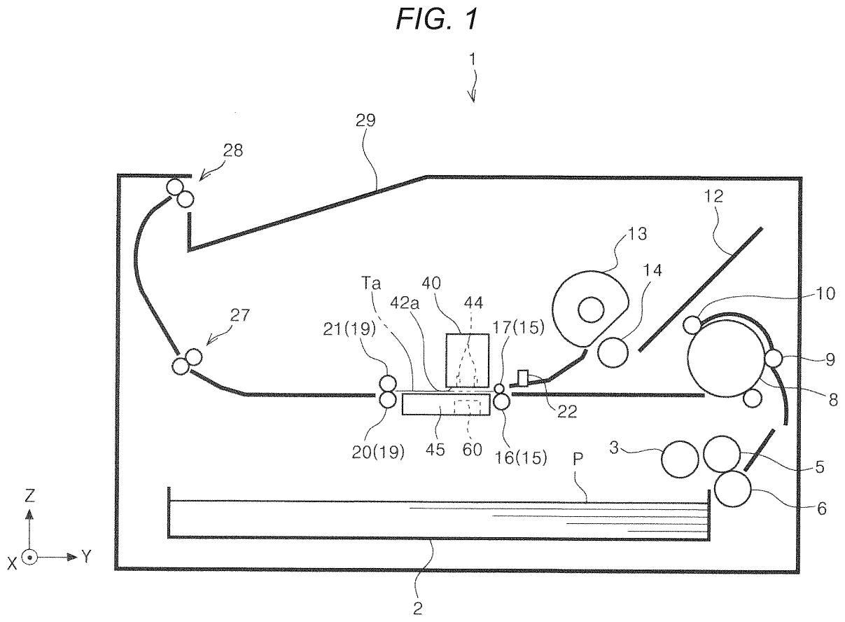

A medium conveyance path in the printer 1 will be described below with reference to FIG. 1. As shown in FIG. 1, the printer 1 includes a medium storage cassette 2 at a bottom thereof. Reference numeral P denotes any of media stored in the medium storage cassette 2. An example of the media is recording paper. The medium storage cassette 2 is provided to be detachably attached from a front side of the printer 1.

A pickup roller 3 driven by a motor (not shown) is provided above the medium storage cassette 2. The pickup roller 3 is capable of advancing to and retracting from the media stored in the medium storage cassette 2 and rotates while being in contact with the media stored in the medium storage cassette 2 to feed the media from the medium storage cassette 2 in the +Y direction.

A feed roller 5 driven by a motor (not shown) and a separation roller 6, to which a rotational torque is applied by a torque limiter (not shown), are provided downstream with respect to the medium storage cassette 2. The media fed from the medium storage cassette 2 are nipped by the feed roller 5 and the separation roller 6 to be separated and the separated medium is further fed downstream.

A reverse roller 8 driven by a motor (not shown) is provided downstream of the feed roller 5 and the separation roller 6. A first nip roller 9 and a second nip roller 10 are provided adjacent the reverse roller 8. The medium is nipped by the reverse roller 8 and the first nip roller 9, further nipped by the reverse roller 8 and the second nip roller 10, and conveyed. A conveyance direction of the medium is reversed from the +Y direction to the −Y direction by the reverse roller 8, and the medium is conveyed downstream.

A first conveyance roller pair 15 including a drive roller 16, which is driven by a motor (not shown), and a driven roller 17, which is rotatably supported, is provided downstream of the reverse roller 8. The medium is conveyed by the first conveyance roller pair 15 to a position where the medium faces a line head 40.

Note that, the printer 1 includes a medium feed path from a medium support portion 12 in addition to a medium feed path from the medium storage cassette 2. The medium support portion 12 supports the medium in an inclined posture, and the supported medium is conveyed to the first conveyance roller pair 15 by a feed roller 13 driven by a motor (not shown). Reference numeral 14 denotes a separation roller to which a rotational torque is applied by a torque limiter (not shown).

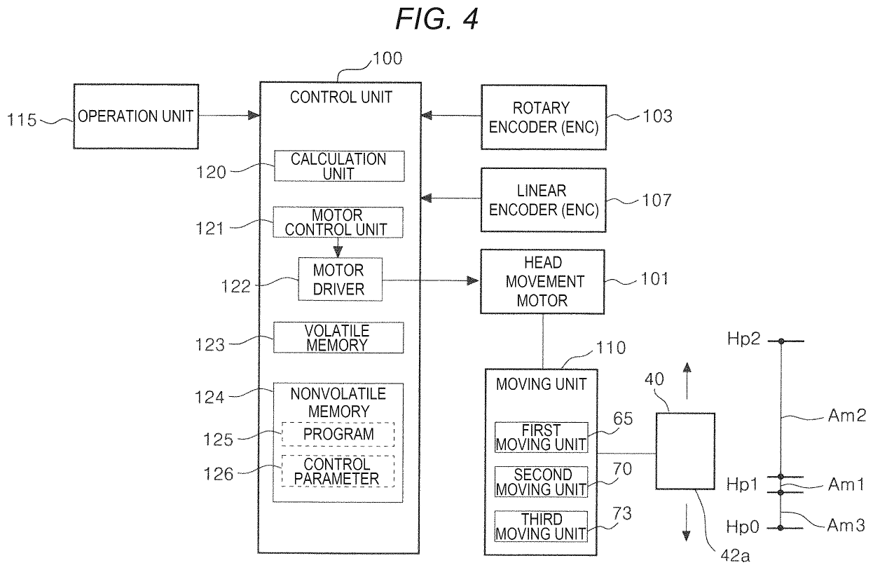

A medium detection unit 22 is provided upstream of the first conveyance roller pair 15. A control unit 100 (see FIG. 4) to be described later can determine, based on detection information of the medium detection unit 22, a position of a front end of the medium with respect to the line head 40, and for example, can position the medium at a recording start position.

The line head 40 is an example of the recording unit that performs recording on the medium. The line head 40 is an example of a liquid ejection head that ejects an ink, which is an example of a liquid, onto the medium to perform recording. The line head 40 is a liquid ejection head in which a plurality of nozzles 44, for ejecting the ink, are arranged to cover the entire medium in the medium width direction. The line head 40 is formed as a liquid ejection head elongated in the medium width direction, and capable of performing recording on the entire medium width region without moving in the medium width direction.

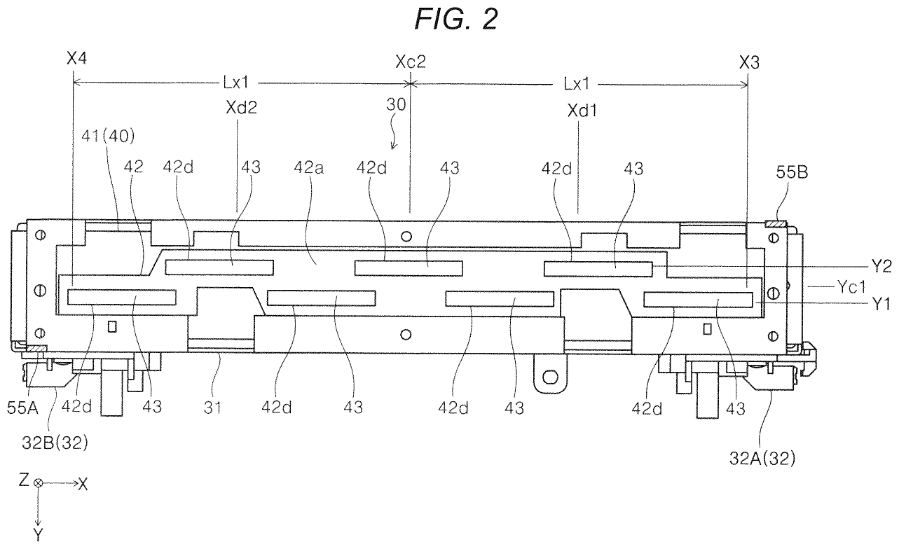

Reference numeral 42a denotes a head surface facing the medium. The head surface 42a may also be referred to as a liquid ejection surface or a nozzle surface. The head surface 42a is formed by a plate member 42 to be described later (see FIG. 2). The head surface 42a is parallel to the medium conveyance direction, that is, the Y-axis direction, at a position facing the line head 40. The head surface 42a is parallel to an X-Y plane. A two-dot chain line denoted by reference numeral Ta is a medium conveyance path between the line head 40 and a facing portion 45. The medium conveyance path Ta is parallel to the X-Y plane.

The printer 1 includes an ink storage (not shown), and the ink ejected from the line head 40 is supplied from the ink storage to the line head 40 via an ink tube (not shown).

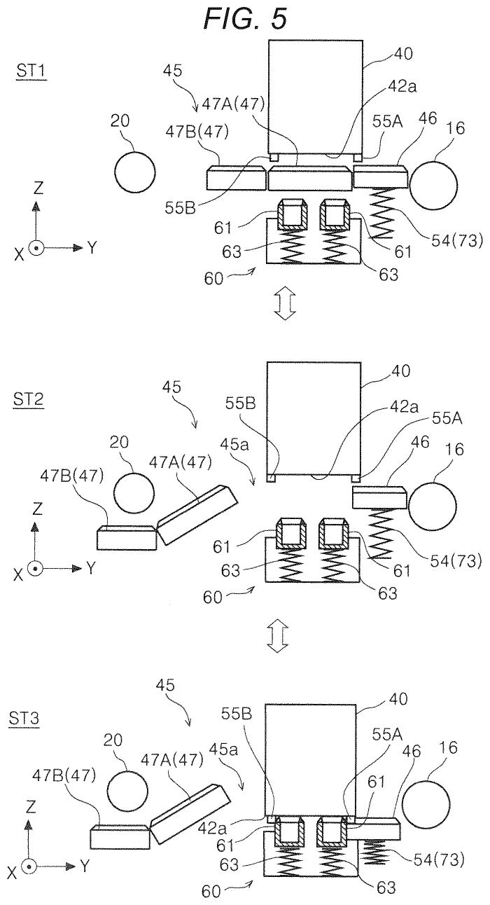

The facing portion 45 is provided at a position facing the head surface 42a of the line head 40. The facing portion 45 according to the embodiment includes an upstream support portion 46 (see FIG. 5) and a shutter 47 (see FIG. 5) to be described later, and defines a gap between the medium and the head surface 42a by supporting the medium by the upstream support portion 46 and the shutter 47. Hereinafter, the gap between the facing portion 45 and the head surface 42a is sometimes referred to as a platen gap.

The line head 40 is movably provided in a direction in which the line head 40 advances and retracts with respect to the facing portion 45, that is, in a direction of adjusting the platen gap. In the embodiment, the direction of adjusting the platen gap is parallel to the Z-axis direction.

Hereinafter, the movement of the line head 40 or other components in the +Z direction is sometimes referred to as “raising”, and the movement thereof in the −Z direction is sometimes referred to as “lowering”.

As shown in FIG. 4, the line head 40 moves along the Z-axis direction by obtaining power from a head movement motor 101, which is an example of a drive source. Here, a movement operation of the line head 40 will be briefly described with reference to FIG. 4. The power from the head movement motor 101 is converted into an operation of the line head 40 in the Z-axis direction by a moving unit 110. The moving unit 110 will be described later.

The control unit 100 that controls the head movement motor 101 raises and lowers the line head 40 according to a thickness of the medium based on a medium type included in received print data, to adjust the platen gap. For example, when a position of the line head 40 in the case of performing recording on plain paper is defined as a first head position, in the case of performing recording on dedicated paper thicker than the plain paper, the line head 40 is positioned at a second head position higher than the first head position. When the medium comes into contact with the line head 40 even when the second head position is selected, the medium is positioned at a third head position higher than the second head position.

In FIG. 4, reference numerals Am1, Am2, and Am3 denote movement regions of the line head 40 with reference to the head surface 42a. The movement regions of the line head 40 include a first region Am1 and a second region Am2 which is farther from the medium conveyance path Ta than the first region Am1. The first region Am1 includes the first head position, the second head position, and the third head position described above. Of course, the first region Am1 may further include another head position. In the embodiment, the movement regions of the line head 40 include a third region Am3 below the first region Am1.

When the line head 40 moves to a position Hp2, which is the uppermost position in the second region Am2, the gap between the facing portion 45 and the head surface 42a is the widest. Accordingly, when a jam occurs, the jammed medium can be removed. Hereinafter, the position Hp2 is referred to as a jam processing position of the line head 40.

A position Hp1 is a recording position when recording is performed on the medium. The position Hp1 changes according to the type of the medium as described above. That is, the recording position Hp1 includes the first head position, the second head position, and the third head position described above.

A position Hp0 is the lowermost position in the third region Am3. This position is a position where a cap portion 61 to be described later covers the head surface 42a, and hereinafter, the position Hp0 is referred to as a cap position of the line head 40.

Returning to FIG. 1, a second conveyance roller pair 19 including a drive roller 20, which is driven by a motor (not shown), and a driven roller 21, which is rotatable when driven, is provided downstream of the line head 40. The medium that has been subjected to recording is conveyed downstream by the second conveyance roller pair 19.

A third conveyance roller pair 27 is provided downstream of the second conveyance roller pair 19, and further a discharge roller pair 28 is provided downstream of the third conveyance roller pair 27. A path between the third conveyance roller pair 27 and the discharge roller pair 28 is formed as a face-down discharge path, and the medium that has been subjected to recording is discharged to a discharge tray 29 by the discharge roller pair 28 in a state where the latest recorded surface faces down.

### Configuration of Line Head

Next, the line head 40, which is an example of the liquid ejection head, will be further described with reference to FIG. 2.

As shown in FIG. 2, the line head 40 includes a base 41 provided with a plate member 42. The base 41 is a structure provided with a flow path along which the ink supplied from the ink storage (not shown) is supplied to head chips 43.

The plate member 42 is a metal plate and forms the head surface 42a.

The plate member 42 is provided with a plurality of head chips 43. The head chips 43 are each provided with the plurality of nozzles 44 (see FIG. 1) along the medium width direction. The plate member 42 and the head chips 43 are provided to be flush with each other.

The head chips 43 are alternately disposed at an upstream position and a downstream position along the X-axis direction, that is, the medium width direction. In the embodiment, four head chips 43 are provided at the upstream position along the medium width direction, and three head chips 43 are provided at the downstream position along the medium width direction. Accordingly, cap portions 61, to be described later for covering the head chips 43, are disposed along the medium width direction alternately at the upstream position and the downstream position.

The line head 40 is provided in a unit frame 31 and constitutes a head unit 30 together with the unit frame 31. The head unit 30 is a structure including the line head 40. Therefore, it can be said that a member constituting the head unit 30 is a member provided in the line head 40.

The line head 40 or the head unit 30 is an example of the recording unit that performs recording on the medium. The power from the head movement motor 101 (see FIG. 4) is transmitted to the unit frame 31, whereby the head unit 30, that is, the line head 40, moves in the Z-axis direction.

Note that, the line head 40 is provided with a first protruding portion 55A and a second protruding portion 55B. These protruding portions will be described later.

### Configuration of Cap Unit

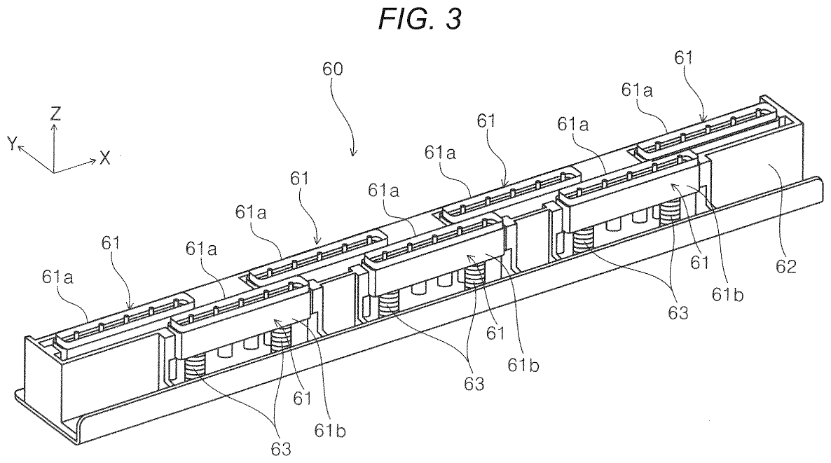

Next, a cap unit 60 will be described with reference to FIG. 3.

The cap unit 60 includes the cap portions 61 that cover the head chips 43. Since the head chips 43 are provided on the head surface 42a, the cap portions 61 can also be referred to as members that cover a portion of the head surface 42a. In addition, since the head chips 43 are each provided with the nozzles 44, the cap portions 61 can also be referred to as members that cover the nozzles 44.

A plurality of cap portions 61 constitute the cap unit 60. The cap unit 60 is provided on a lower side of the facing portion 45.

The cap unit 60 includes the plurality of cap portions 61 on a base portion 62.

The cap portions 61 each have a shape elongated in the X-axis direction, and include a cap body portion 61b made of a resin material or the like, and an elastic portion 61a, which is a portion in contact with the head surface 42a and is made of an elastic material such as rubber. The cap body portion 61b is held by the base portion 62 so as to be displaceable in the Z-axis direction, and a movement limit thereof in the +Z direction is defined by a regulating unit (not shown) formed on the base portion 62. The cap body portion 61b is pressed in the +Z direction by a cap spring 63, which is an example of a pressing member. In the embodiment, two cap springs 63 are provided for each cap body portion 61b.

A waste liquid tube (not shown) is coupled to each cap body portion 61b. The waste liquid tube is coupled to a pump (not shown). When the pump is operated in the state where the cap portions 61 cover the head surfaces 42a, a negative pressure is generated in the cap portions 61, whereby the ink is drawn via the nozzles 44 of the line head 40.

The cap portions 61 are alternately disposed at the upstream position and the downstream position along the X-axis direction, that is, the medium width direction. In the embodiment, four cap portions 61 are provided at the upstream position, that is, in the +Y direction, and three cap portions 61 are provided at the downstream position, that is, in the −Y direction.

Such disposition of the cap portions 61 corresponds to the disposition of the head chips 43 in the line head 40.

The cap portions 61 are exposed when the shutter 47 to be described later is moved from a blocking position to an open position.

### Configuration of Facing Portion

Next, the facing portion 45 will be further described with reference to FIG. 5.

As shown in FIG. 5, the facing portion 45 facing the line head 40 includes the upstream support portion 46 and the shutter 47 positioned downstream of the upstream support portion 46. In the embodiment, the shutter 47 is formed by rotatably coupling an upstream shutter 47A and a downstream shutter 47B. The shutter 47 is movable along the medium conveyance direction and is movable between the blocking position indicated by a state ST1 in FIG. 5 and the open position indicated by states ST2 and ST3 in FIG. 5 by power from a motor (not shown).

When the shutter 47 moves to the open position, an opening 45a is formed in the facing portion 45, and the cap portion 61 is exposed inside the opening 45a.

In a state where the shutter 47 is at the open position, the cap portion 61 can cover the head chip 43 by lowering the line head 40, as shown in the state ST3 in FIG. 5. At this time, the cap portion 61 is slightly pressed down in the −Z direction against a pressing force from the cap spring 63, whereby the cap portion 61 comes into close contact with the head surface 42a. Note that, the lowering of the line head 40 when the cap portion 61 is brought into close contact with the head surface 42a is sometimes referred to as a “capping operation”.

When a power supply of the printer 1 is turned off or in a recording standby state where the power supply is turned on, the control unit 100 maintains the head chip 43 covered by the cap portion 61 in the state where the shutter 47 is at the open position. In addition, during a flushing operation for preventing the nozzles 44 from clogging, the control unit 100 causes the ink to be ejected toward the cap portion 61 in the state where the shutter 47 is at the open position.

When recording data is received and recording is performed, the control unit 100 raises the line head 40 to separate the head surface 42a from the cap portion 61, and moves the shutter 47 to the blocking position. Accordingly, the conveyed medium is prevented from entering the opening 45a of the facing portion 45 or the posture of the medium is prevented from being disturbed. In addition, entry of foreign matters such as paper dust into the cap portion 61 during the conveyance of the medium, and deterioration of the performance of the cap portion 61 are prevented.

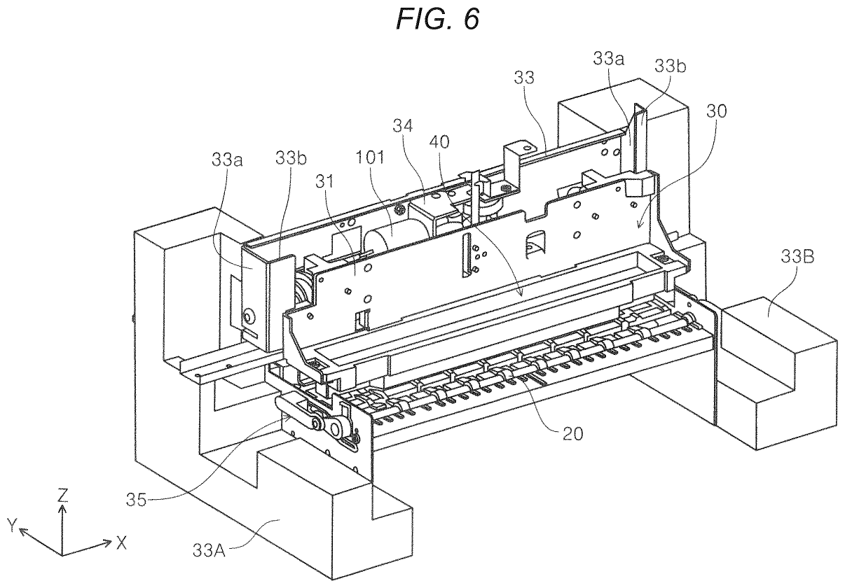

Note that, in the embodiment, the shutter 47 moves between the blocking position and the open position by a link mechanism 35 (see FIG. 6), which is operated by reverse rotation of the drive roller 20 constituting the second conveyance roller pair 19.

Note that, the upstream support portion 46 is provided to be movable in the Z-axis direction, and is pressed in the +Z direction by a coil spring 54, which is an example of the pressing member. However, the movement of the upstream support portion 46 in the +Z direction is regulated at a predetermined position by coming into contact with a regulating unit (not shown).

Then, in the case of performing the capping operation, the line head 40 presses down the upstream support portion 46 in the −Z direction against a pressing force from the coil spring 54.

### Configuration of Moving Unit for Moving Line Head

Hereinafter, the moving unit 110 that converts the power from the head movement motor 101 (see FIG. 4) into an operation of the line head 40 in the Z-axis direction will be described.

First, the position of the line head 40 in the Z-axis direction can be grasped by the control unit 100 based on detection information transmitted from a rotary encoder 103 (see FIG. 4) and detection information transmitted from a linear encoder 107 (see FIG. 4). Note that, hereinafter, the “encoder” is abbreviated as “ENC”.

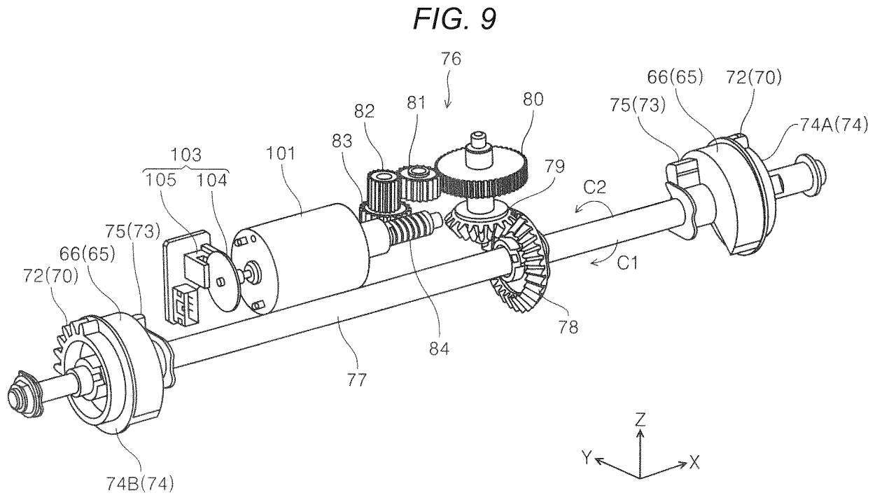

As shown in FIG. 9, the rotary ENC 103 includes a rotary scale 104 provided on a motor output shaft of the head movement motor 101 and a second detection unit 105 for detecting the rotary scale 104. The rotary ENC 103 detects a light transmission scale of the rotary scale 104 and outputs a detection pulse signal including a number of pulses proportional to a rotation amount of the motor output shaft.

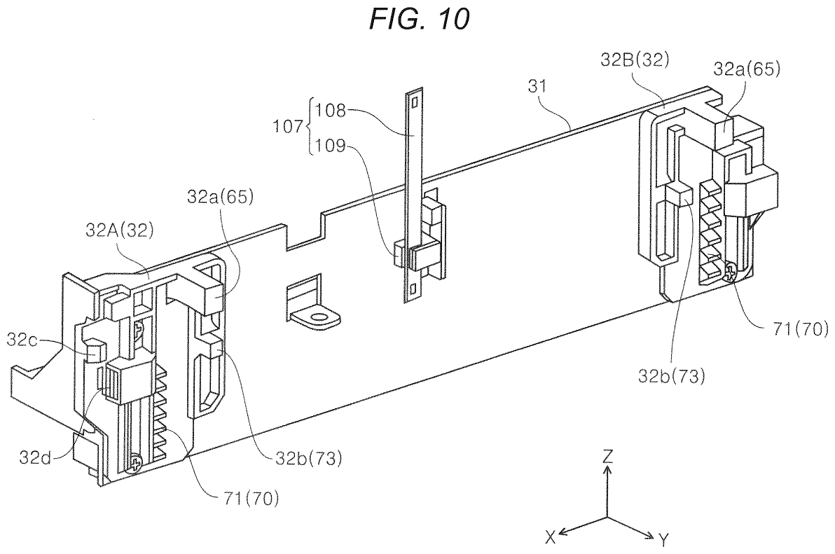

As shown in FIG. 10, the linear ENC 107 includes a linear scale 108 provided in a guide frame 33 to be described later and a first detection unit 109 for detecting a movement of the linear scale 108. The linear ENC 107 detects a light transmission scale of the linear scale 108 and outputs a detection pulse signal including a number of pulses proportional to a movement amount of the head unit 30.

As described above, the head unit 30 including the line head 40 includes the unit frame 31 as a base body, and the line head 40 is provided in the unit frame 31.

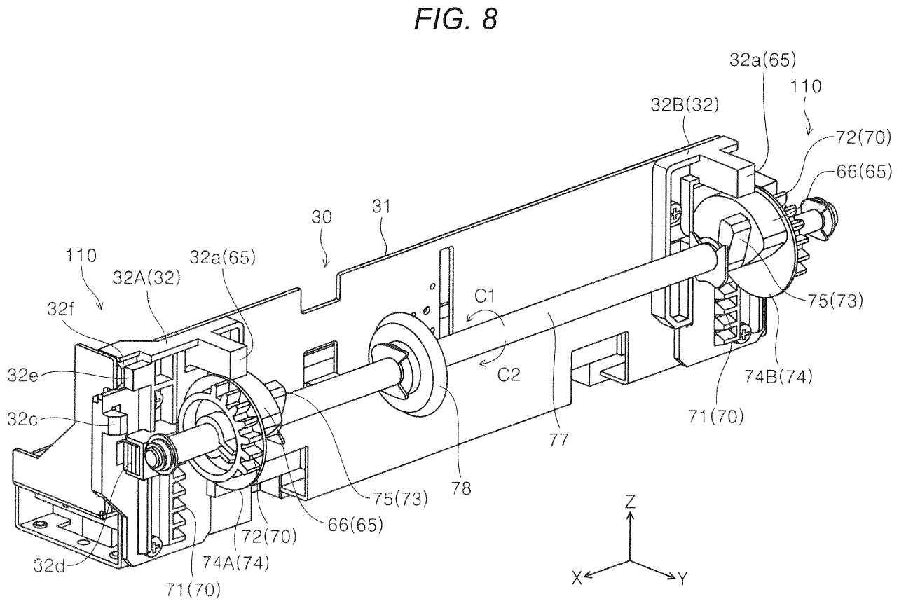

As shown in FIG. 8, a rack member 32 is provided in the unit frame 31 at each one of an end portion in the +X direction and an end portion in the −X direction. In the unit frame 31, the rack member 32 provided at the end portion in the +X direction is denoted by reference numeral 32A, and the rack member 32 provided at the end portion in the −X direction is denoted by reference numeral 32B. Hereinafter, the rack members 32A and 32B are collectively referred to as the rack member 32 when there is no need to distinguish therebetween.

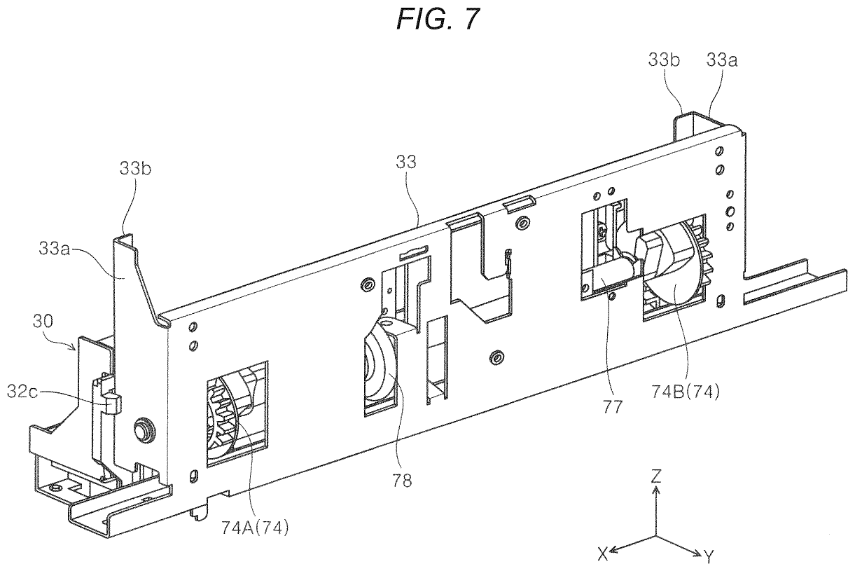

As shown in FIG. 7, the guide frame 33 is provided in the +Y direction with respect to the unit frame 31. In the guide frame 33, a first guide portion 33a is formed at each one of an end portion in the +X direction and an end portion in the −X direction. The first guide portion 33a is a portion forming a surface parallel to a Y-Z plane. Further, a second guide portion 33b is formed at an end portion of the first guide portion 33a in the −Y direction. The second guide portion 33b is a portion forming a surface parallel to an X-Z plane. Note that, as shown in FIG. 6, the guide frame 33 is supported by base frames 33A and 33B provided at a gap in the X-axis direction.

As shown in FIG. 8, the rack member 32 is provided with guided portions 32c and 32d. The guided portions 32c and 32d can sandwich the first guide portion 33a of the guide frame 33 in the X-axis direction. The rack member 32 is provided with guided portions 32e and 32f. The guided portions 32e and 32f can sandwich the second guide portion 33b of the guide frame 33 in the Y-axis direction. With such a configuration, the unit frame 31, that is, the head unit 30, is guided in the Z-axis direction by the guide frame 33.

Note that, the shape of the rack member 32B is line-symmetric with the shape of the rack member 32A, with the Y axis as a symmetric axis, at an intermediate position between the rack member 32A and the rack member 32B in the X-axis direction.

Next, as shown in FIG. 7, a shaft 77 parallel to the X-axis direction is rotatably supported by the guide frame 33. In the shaft 77, a rotating body 74 is provided near each one of an end portion in the +X direction and an end portion in the −X direction. In the shaft 77, the rotating body 74 provided near the +X direction end portion is denoted by reference numeral 74A, and the rotating body 74 provided at the −X direction end portion is denoted by reference numeral 74B. Hereinafter, the rotating bodies 74A and 74B are collectively referred to as the rotating body 74 when there is no need to distinguish therebetween.

Note that, the shape of the rotating body 74B is line-symmetric with the shape of the rotating body 74A, with the Y axis as a symmetric axis, at an intermediate position between the rotating body 74A and the rotating body 74B in the X-axis direction.

The rotating body 74 rotates integrally with the shaft 77. Note that, in the following, rotation directions of the shaft 77, the rotating body 74, and a pinion 72, a cam 66, and a press-down portion 75, to be described later, are sometimes expressed using reference numerals C1 and C2 shown in the drawing.

As shown in FIG. 9, a first bevel gear 78 is provided between the rotating body 74A and the rotating body 74B. The first bevel gear 78 rotates integrally with the shaft 77. The first bevel gear 78 constitutes a speed reduction mechanism 76 (see FIG. 9) that transmits the power from the head movement motor 101 to the shaft 77.

Hereinafter, the speed reduction mechanism 76 will be described with reference to FIG. 9.

The speed reduction mechanism 76 includes the first bevel gear 78, a second bevel gear 79, a spur gear 80, a spur gear 81, a spur gear 82, a worm wheel 83, and a cylindrical worm 84.

The second bevel gear 79 meshes with the first bevel gear 78. The second bevel gear 79 and the spur gear 80 are integrally formed and are rotatably supported by an attachment frame 34 (see FIG. 6). The attachment frame 34 is fixed by being screwed to the guide frame 33. In addition, the head movement motor 101 is fixed by being screwed to the attachment frame 34.

The spur gear 81 meshes with the spur gear 80. The spur gear 81 is rotatably provided on the attachment frame 34 (see FIG. 6). The spur gear 81 meshes with the spur gear 82. The spur gear 82 and the worm wheel 83 are integrally formed and are rotatably provided on the attachment frame 34 (see FIG. 6). The cylindrical worm 84 meshes with the worm wheel 83, and the worm wheel 83 and the cylindrical worm 84 constitute a worm gear mechanism. The cylindrical worm 84 is provided on an output shaft (not shown) of the head movement motor 101, and accordingly, when the head movement motor 101 rotates, the rotation is transmitted to the shaft 77 via the speed reduction mechanism 76, and the shaft 77 rotates.

Note that, in the embodiment, a speed reduction ratio of the speed reduction mechanism 76, specifically, a speed reduction ratio of the power transmission from the head movement motor 101 to the shaft 77 is 111. The speed reduction ratio is preferably larger than 1, more preferably larger than 10, and still more preferably larger than 100 as in the embodiment.

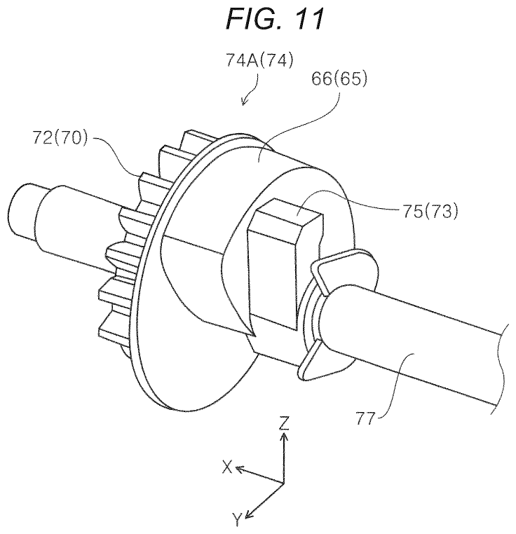

Next, the rotating body 74 is provided with the pinion 72 constituting a rack and pinion mechanism as shown in FIG. 11. The rotating body 74 is provided with the cam 66. In addition, the rotating body 74 is provided with the press-down portion 75 having a lever shape.

As shown in FIGS. 8, 10, and 13 to 18, a rack 71 constituting the rack and pinion mechanism is formed in the rack member 32. The rack 71 meshes with the pinion 72. Therefore, when the pinion 72 rotates, the head unit 30, that is, the line head 40, moves in the Z-axis direction. Specifically, when the pinion 72 rotates in the rotation direction C1, the line head 40 is lowered, and when the rack 71 rotates in the rotation direction C2, the line head 40 is raised.

The rack 71 and the pinion 72 constitute a second moving unit 70 that moves the line head 40 in the second region Am2.

Note that, since the second moving unit 70 raises and lowers the line head 40 by the rack and pinion mechanism, an operation of raising and lowering the line head 40 by the second moving unit 70 is sometimes hereinafter referred to as “rack and pinion drive”.

As shown in FIGS. 8, 10, and 13 to 18, the rack member 32 is provided with a contact portion 32a that can come into contact with the cam 66. The contact portion 32a is provided to protrude in the +Y direction, and the cam 66 is disposed below the contact portion 32a. The position of the head unit 30, that is, the line head 40, in the Z-axis direction is defined by being supported by the cam 66 via the contact portion 32a in the first region Am1. In other words, the head unit 30, that is, the line head 40, can be placed on the cam 66 by using its own weight. Note that, the head unit 30, that is, the line head 40, may be placed on the cam 66 only by its own weight, or may be placed on the cam 66 by receiving a pressing force in a direction including a vertically downward component from a spring or the like. When the head unit 30, that is, the line head 40, receives a pressing force in a direction including a vertically downward component from a spring or the like and is placed on the cam 66, the head unit 30, that is, the line head 40, is prevented from rising up, and the platen gap is stabilized.

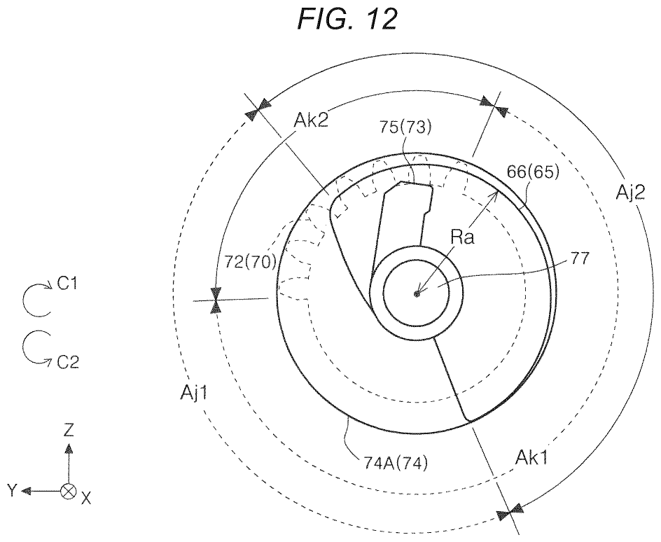

An outer peripheral surface of the cam 66 is formed such that a distance from a shaft center of the shaft 77, that is, a radius, changes along a circumferential direction (see FIG. 12). Therefore, when the cam 66 rotates in a state where the contact portion 32a is placed on the cam 66, the head unit 30, that is, the line head 40, moves in the Z-axis direction. Specifically, when the cam 66 rotates in the rotation direction C1, the line head 40 is lowered, and when the cam 66 rotates in the rotation direction C2, the line head 40 is raised.

The cam 66 and the contact portion 32a constitute a first moving unit 65 that moves the line head 40 in the first region Am1.

Note that, since the first moving unit 65 raises and lowers the line head 40 by the cam 66, an operation of raising and lowering the line head 40 by the first moving unit 65 is sometimes hereinafter referred to as “cam drive”.

The first moving unit 65 and the second moving unit 70 described above constitute the moving unit 110 (see FIG. 4).

As shown in FIGS. 10 and 13 to 18, the rack member 32 is provided with a pressed portion 32b that can come into contact with the press-down portion 75. The pressed portion 32b is provided to protrude in the +Y direction, and is configured such that the press-down portion 75 can come into contact with the pressed portion 32b from above.

When the rotating body 74 rotates in the rotation direction C1, the press-down portion 75 presses the pressed portion 32b from above, and can press down the head unit 30, that is, the line head 40, in the −Z direction, that is, downward. The press-down portion 75 and the pressed portion 32b constitute a third moving unit 73 that lowers the line head 40 in the third region Am3. Note that, when the line head 40 is to be raised in the third region Am3, the line head 40 is raised by receiving the pressing force from the coil spring 54 (see FIG. 5), which is an example of the pressing member described above. Therefore, the coil spring 54 (see FIG. 5) also constitutes the third moving unit 73.

Note that, since the third moving unit 73 raises and lowers the line head 40 by the press-down portion 75 having a lever shape, an operation of raising and lowering the line head 40 by the third moving unit 73 is sometimes hereinafter referred to as “lever drive”.

In the embodiment, the third moving unit 73 constitutes the moving unit 110 (see FIG. 4).

FIG. 12 shows a formation range of the cam 66 and the pinion 72.

The pinion 72 has a first phase region Ak1 in which a part of teeth are missing and a second phase region Ak2 in which teeth are formed. Note that, hereinafter, the “pinion 72” refers to a portion of the second phase region Ak2 in which teeth are formed for convenience.

The cam 66 has a non-support phase region Aj1 that does not support the contact portion 32a and a support phase region Aj2 that can support the contact portion 32a. In the support phase region Aj2, a radius Ra of the outer peripheral surface supporting the contact portion 32a changes along the circumferential direction. Note that, hereinafter, the “cam 66” refers to a portion of the support phase region Aj2 for convenience.

Hereinafter, the operations of the first moving unit 65, the second moving unit 70, and the third moving unit 73 will be further described.

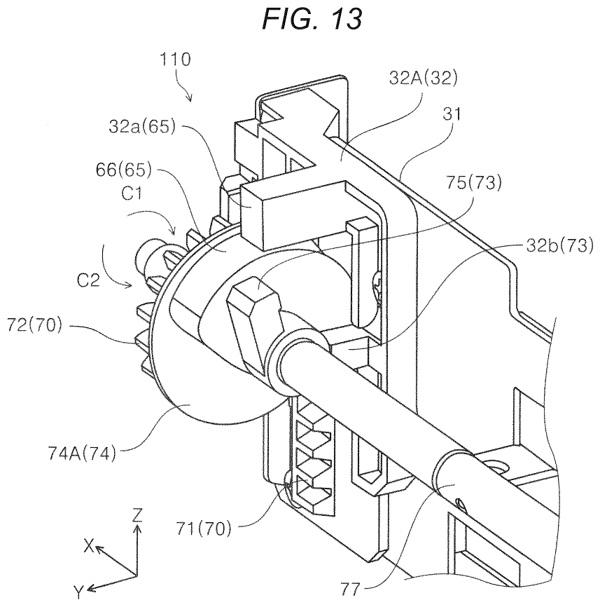

FIG. 13 shows a state where the line head 40 is at the first head position in the first region Am1. In this state, the first moving unit 65 functions. That is, the head unit 30 is in a state of being placed on the cam 66 by using its own weight. In this state, the rack 71 is not meshed with the pinion 72, and the press-down portion 75 is separated from the pressed portion 32b.

In the first region Am1, that is, a region where recording is performed on the medium, it is necessary to accurately determine the position of the line head 40, and thus the cam drive by the first moving unit 65 is adopted.

When the shaft 77 rotates in the rotation direction C2 from the state in FIG. 13, the cam 66 also rotates in the rotation direction C2. In the embodiment, the outer peripheral surface of the cam 66 is formed such that the radius changes by 0.01 mm when the cam 66 rotates by 1°. That is, when the cam 66 rotates by 1°, the line head 40 is raised or lowered by 0.01 mm.

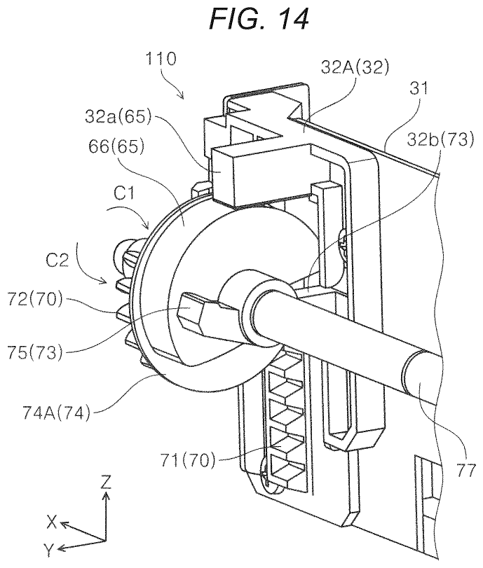

FIG. 14 shows a state where the shaft 77 rotates in the rotation direction C2 from the state in FIG. 13 and the line head 40 moves to the second head position in the first region Am1.

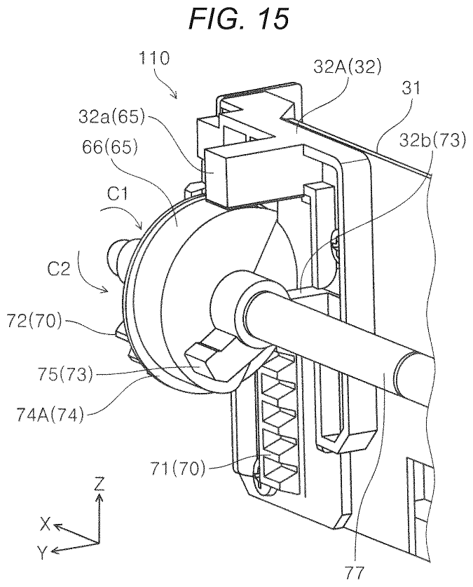

FIG. 15 shows a state where the shaft 77 further rotates in the rotation direction C2 from the state in FIG. 14 and the line head 40 moves to the third head position in the first region Am1.

In this manner, in the first region Am1, since the first moving unit 65 in which a movement amount of the line head 40 per unit rotation angle of the shaft 77 is small functions, the line head 40 can be accurately positioned at each head position.

Note that, in the case where the line head 40 is lowered from the state in FIG. 15 and positioned at the second head position or the first head position, or positioned at the cap position Hp0, the shaft 77 is rotated in the rotation direction C1.

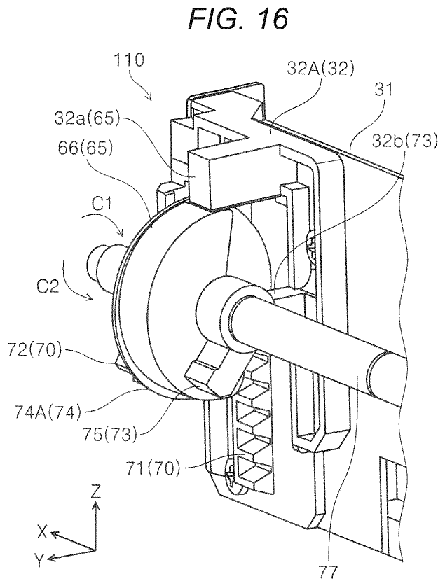

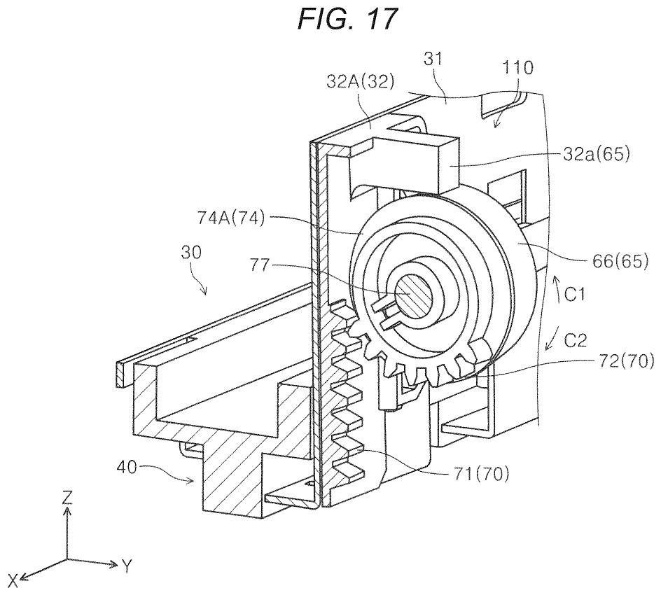

Next, FIGS. 16 and 17 show a state where the shaft 77 further rotates in the rotation direction C2 from the state in FIG. 15, and FIGS. 16 and 17 show the same state. The state shown in FIGS. 16 and 17 is a state where the contact portion 32a is placed on a portion where the radius Ra of the cam 66 is the largest, and when the shaft 77 further rotates in the rotation direction C2 from this state, the contact portion 32a is separated from the cam 66.

This state is a state where the rack 71 starts to mesh with the pinion 72 as shown in FIG. 17.

In this manner, when the line head 40 transitions from the first region Am1 to the second region Am2, the line head 40 transitions from a state of being moved by the first moving unit 65 to a state of being moved by the second moving unit 70.

Note that, when the cam drive by the first moving unit 65 transitions to the rack and pinion drive by the second moving unit 70, as shown in FIGS. 16 and 17, a state where the cam 66 is in contact with the contact portion 32a, that is, the line head 40, and the pinion 72 meshes with the rack 71 is temporarily formed. Accordingly, even when the contact portion 32a is separated from the cam 66, the line head 40 is not thus lowered.

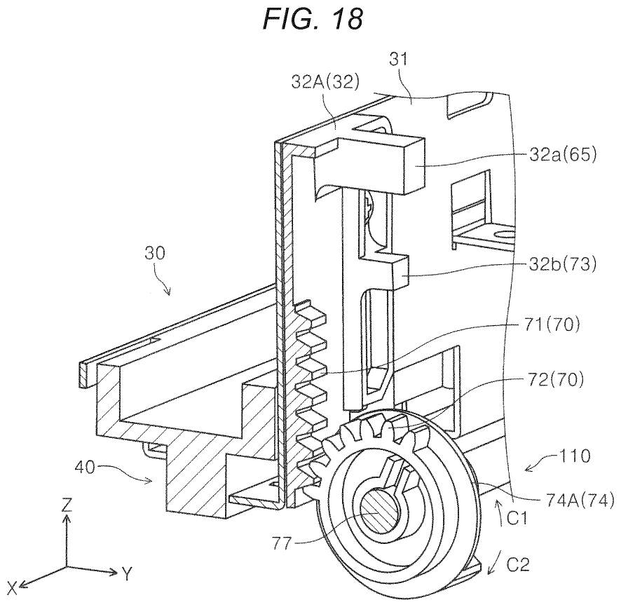

FIG. 18 shows a state where the shaft 77 further rotates in the rotation direction C2 from the state in FIGS. 16 and 17 and the head unit 30 is raised to the most +Z direction position by the second moving unit 70, that is, the rack and pinion mechanism. This state is a state where the line head 40 is most separated from the facing portion 45, and is the jam processing position Hp2 when paper clogging occurs.

Note that, in the embodiment, the rack and pinion mechanism including the rack 71 and the pinion 72 is configured such that the line head 40 is raised or lowered by about 0.26 mm when the pinion 72 rotates by 1°. Therefore, the movement amount of the line head 40 per unit rotation angle of the shaft 77 in the second moving unit 70 is extremely larger than in the first moving unit 65.

Note that, in the embodiment, the platen gap when the line head 40 is at the jam processing position Hp2 is 30 mm to 40 mm.

In the above process, that is, in the process of raising the line head 40 from the first head position to the jam processing position, it is not necessary to rotate the shaft 77 in the rotation direction C2 and switch the rotation direction.

Note that, in the movement region of the line head 40, the lowermost position is the cap position Hp0, and the uppermost position is the jam processing position Hp2. Similarly, in the process of raising the line head 40 from the cap position Hp0 to the jam processing position Hp2, it is not necessary to rotate the shaft 77 in the rotation direction C2 and switch the rotation direction.

Note that, in the case of lowering the line head 40 from the jam processing position Hp2, the above is reversed. That is, when the line head 40 transitions from the second region Am2 to the first region Am1, the rack and pinion drive by the second moving unit 70 transitions to the cam drive by the first moving unit 65. Specifically, when the line head 40 transitions from the second region Am2 to the first region Am1, the pinion 72 is separated from the rack 71, and the contact portion 32a is in a state of being placed on the cam 66.

In the process of lowering the line head 40 from the jam processing position Hp2 to the first head position, it is not necessary to rotate the shaft 77 in the rotation direction C1 and switch the rotation direction. Similarly, in the process of lowering the line head 40 from the jam processing position Hp2 to the cap position Hp0, it is not necessary to rotate the shaft 77 in the rotation direction C1 and switch the rotation direction.

In addition, when the rack and pinion drive by the second moving unit 70 transitions to the cam drive by the first moving unit 65, as shown in FIGS. 16 and 17, the state where the cam 66 is in contact with the contact portion 32a, that is, the line head 40, and the pinion 72 meshes with the rack 71 is temporarily formed. Accordingly, even when the pinion 72 is separated from the rack 71, the line head 40 is not thus lowered.

Next, a case where the line head 40 is lowered from the first region Am1, that is, a case where the capping operation is performed will be described. Note that, in the case of performing the capping operation, when the shutter 47 (see FIG. 5) provided in the facing portion 45 is at the blocking position, the shutter 47 is moved from the blocking position to the open position as described above prior to the capping operation.

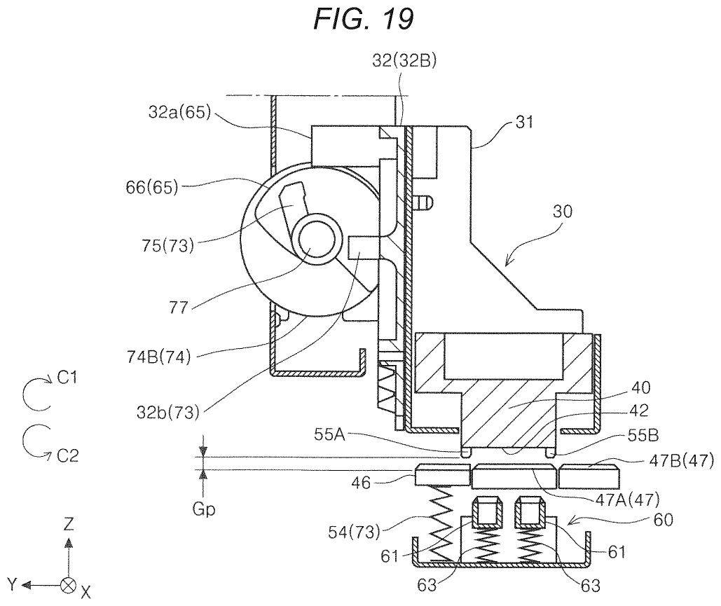

FIG. 19 shows a state where the line head 40 is in the first region Am1, more specifically, at the first head position. In the head unit 30, the first protruding portion 55A and the second protruding portion 55B protruding toward the facing portion 45 are provided at positions facing the facing portion 45. Hereinafter, the first protruding portion 55A and the second protruding portion 55B are sometimes collectively referred to as a protruding portion 55.

In the state in FIG. 19, a gap Gp is formed between the protruding portion 55 and the facing portion 45.

Note that, in FIG. 2, the first protruding portion 55A and the second protruding portion 55B are provided at positions outside a medium conveyance region in the X-axis direction. The medium conveyance region is a region between a position X3 and a position X4 in FIG. 2 or a region slightly wider than this. The position X3 and the position X4 will be described later.

The first protruding portion 55A and the second protruding portion 55B are provided on both sides of a position Xc2 in the X-axis direction. The position Xc2 will be described later. As an example, the first protruding portion 55A and the second protruding portion 55B are provided on the unit frame 31.

The disposition of the first protruding portion 55A and the second protruding portion 55B will be described later, but one or both of the first protruding portion 55A and the second protruding portion 55B may be provided in the medium conveyance region in the X-axis direction.

In the embodiment, the first protruding portion 55A faces the upstream support portion 46, and the second protruding portion 55B faces the upstream shutter 47A. However, the present disclosure is not limited thereto, and the first protruding portion 55A and the second protruding portion 55B may face the upstream shutter 47A, or the first protruding portion 55A may face the upstream shutter 47A and the second protruding portion 55B may face the downstream shutter 47B.

In the case of performing the capping operation from the state in FIG. 19, the shutter 47 is open and the shaft 77 is rotated in the rotation direction C1. Accordingly, the radius Ra of the cam 66 at the position where the contact portion 32a comes into contact with the outer peripheral surface of the cam 66 is reduced, and thus the line head 40 is lowered.

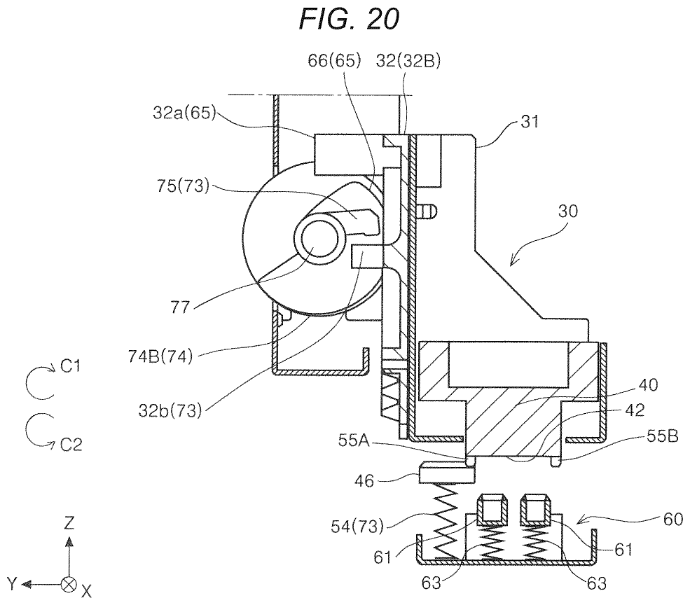

When the line head 40 is lowered, the first protruding portion 55A comes into contact with the upstream support portion 46 as shown in FIG. 20, and the lowering of the line head 40 stops. In this state, the head unit 30 is in a state of being placed on the facing portion 45 by using its own weight. Note that, when the line head 40 is lowered and the head unit 30 is placed on the upstream support portion 46 in a state where the shutter 47 is open, the pressing force from the coil spring 54 that presses the upstream support portion 46 upward is set to a magnitude such that the upstream support portion 46 is not displaced downward when the head unit 30 is placed on the upstream support portion 46 by using its own weight.

Note that, the expression “the line head 40 is placed on the facing portion 45 by using its own weight” is not limited to a form in which the line head 40 is placed on the facing portion 45 only by its own weight, but also includes a form in which the line head 40 is placed on the facing portion 45 by receiving a pressing force in a direction including a vertically downward component from a spring or the like in addition to its own weight. When the head unit 30, that is, the line head 40, receives a pressing force in a direction including a vertically downward component from a spring or the like and is placed on the facing portion 45, the head unit 30, that is, the line head 40, is prevented from rising up, and the platen gap is stabilized.

Note that, at a time when the protruding portion 55 comes into contact with the facing portion 45, since the press-down portion 75 does not come into contact with the pressed portion 32b, a period in which the line head 40 maintains the stopped state occurs even when the shaft 77, that is, the rotating body 74, rotates in the rotation direction C1. This period is an idling period of the head movement motor 101 to be described in detail later.

Then, when the shaft 77 further rotates in the rotation direction C1 from the state shown in FIG. 20, the press-down portion 75 comes into contact with the pressed portion 32b and presses down the pressed portion 32b. That is, the lever drive by the third moving unit 73 is started, and accordingly, the head unit 30, that is, the line head 40, is lowered. At this time, the head unit 30 presses down the upstream support portion 46 against the pressing force from the coil spring 54.

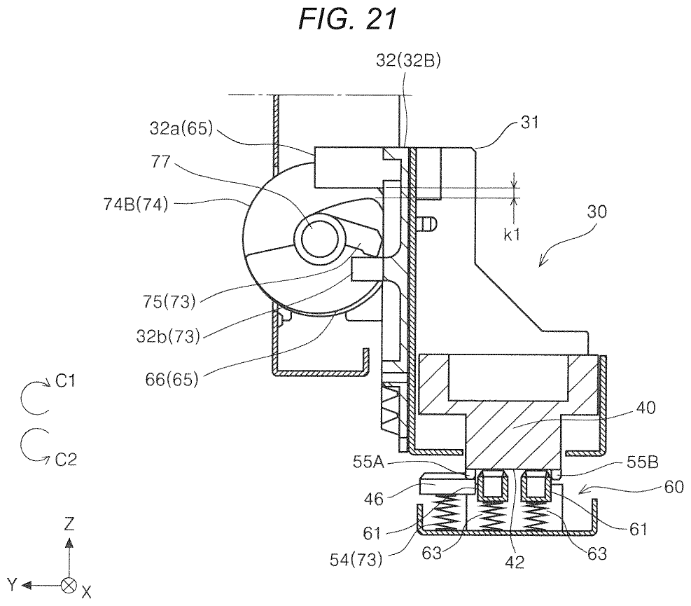

FIG. 21 shows a state where the line head 40 is at the cap position Hp0. In the process in which the line head 40 moves to the cap position Hp0, the head surface 42a of the line head 40 comes into contact with the cap portion 61, and the head surface 42a further presses down the cap portion 61 by a predetermined amount against the pressing force from the cap spring 63. Accordingly, the cap portion 61 comes into close contact with the head surface 42a.

In the case of raising the head unit 30, that is, the line head 40, from the state in FIG. 21, the shaft 77 is rotated in the rotation direction C2. Accordingly, since the press-down portion 75 is displaced upward, the line head 40 is raised by the spring force from the coil spring 54 while the position in the Z-axis direction is regulated by the press-down portion 75, and returns to the state in FIG. 20.

When the shaft 77 is further rotated in the rotation direction C2 from the state in FIG. 20, it is switched to the cam drive by the first moving unit 65.

Here, in FIG. 21, reference numeral k1 denotes a clearance formed between the cam 66 and the contact portion 32a. When there is no clearance k1, a state where the cam 66 supports the line head 40 and a state where the press-down portion 75 presses down the pressed portion 32b, that is, the line head 40, are formed at the same time, and there is a concern that the rotating body 74 is locked and cannot rotate.

However, by providing the clearance k1, the state where the cam 66 supports the line head 40 and the state where the press-down portion 75 presses down the line head 40 are not formed at the same time, and locking of the rotating body 74 can be avoided.

In the embodiment, as described above, the line head 40 includes the rack member 32 in which the pressed portion 32b, the contact portion 32a, and the rack 71 are integrally formed. Accordingly, a relative positional relationship among the pressed portion 32b, the contact portion 32a, and the rack 71 is easily determined. As a result, it is possible to reliably implement a configuration in which the state where the cam 66 supports the line head 40 and the state where the press-down portion 75 presses down the line head 40 are not formed at the same time.

Note that, even when the cam 66 is separated from the contact portion 32a to form the clearance k1, the line head 40 is not lowered since the line head 40 is supported by the upstream support portion 46. However, instead of the configuration in which the upstream support portion 46 supports the line head 40 in a state where the cam 66 is separated from the contact portion 32a to form the clearance k1, a configuration in which the cap portion 61 supports the line head 40 may be used.

In such a configuration, specifically, the line head 40 is disposed at a position separated from the upstream support portion 46 in the −Y direction. In the case of such a configuration, when the cam 66 is separated from the contact portion 32a in lowering the line head 40 in a state where the shutter 47 is open, the cap portion 61 supports the line head 40. In such a configuration, the upstream support portion 46 may be fixedly provided without being displaced in the Z-axis direction.

As described above, the printer 1 includes the medium conveyance path Ta for conveying the medium, the line head 40 movable with respect to the medium conveyance path Ta in a direction intersecting the recorded surface of the medium, and the moving unit 110 for moving the line head 40.

The movement regions of the line head 40 include the first region Am1 and the second region Am2 farther from the medium conveyance path Ta than the first region Am1.

The moving unit 110 includes the first moving unit 65 that moves the line head 40 in the first region Am1 and the second moving unit 70 that moves the line head 40 in the second region Am2.

When the line head 40 transitions from the first region Am1 to the second region Am2, the line head 40 transitions from the state of being moved by the first moving unit 65 to the state of being moved by the second moving unit 70. In addition, when the line head 40 transitions from the second region Am2 to the first region Am1, the line head 40 transitions from the state of being moved by the second moving unit 70 to the state of being moved by the first moving unit 65.

The first moving unit 65 and the second moving unit 70 are driven by the head movement motor 101, which is a common drive source. Accordingly, compared to a configuration in which the first moving unit 65 and the second moving unit 70 are driven by separate drive sources, an increase in cost of the printer 1 can be prevented, and the size of the printer 1 can be reduced.

When the line head 40 transitions from the first region Am1 to the third region Am3, the line head 40 transitions from the state of being moved by the first moving unit 65 to a state of being moved by the third moving unit 73. In addition, when the line head 40 transitions from the third region Am3 to the first region Am1, the line head 40 transitions from the state of being moved by the third moving unit 73 to the state of being moved by the first moving unit 65.

That is, in the embodiment, in addition to the first moving unit 65 and the second moving unit 70, the third moving unit 73 is driven by one head movement motor 101. As a result, an increase in cost of the printer 1 can be prevented, and the size of the printer 1 can be reduced.

In addition, in the embodiment, the first moving unit 65 is a cam that rotates by the power from the head movement motor 101, and includes the cam 66 that moves the line head 40 by rotating in a state of supporting the line head 40. Accordingly, the position of the line head 40 can be finely adjusted at a position close to the medium conveyance path Ta. As a result, the line head 40 can be positioned at an appropriate position according to the thickness of the medium.

In addition, in the embodiment, the second moving unit 70 includes the rack 71 provided in the line head 40 and the pinion 72 that meshes with the rack 71 and that moves the line head 40 by being rotated by the power from the head movement motor 101. Accordingly, even when the second region Am2 is ensured to be large, the line head 40 can be largely moved accordingly, and convenience of a maintenance work or the like can be improved.

However, the first moving unit 65 is not limited to the cam drive, and other configurations such as rack and pinion drive may be adopted. In addition, the second moving unit 70 is not limited to the rack and pinion drive, and other configurations such as cam drive may be adopted.

In addition, in the embodiment, the cam 66 and the pinion 72 are integrally formed to constitute the rotating body 74. Accordingly, the power can be easily transmitted from the head movement motor 101 to the first moving unit 65 and the second moving unit 70. In addition, since it is not necessary to individually transmit the power from the head movement motor 101 to the first moving unit 65 and the second moving unit 70, the number of parts can be reduced. As a result, an increase in cost of the printer 1 can be prevented, and the size of the printer 1 can be reduced.

However, the cam 66 and the pinion 72 may be formed separately.

Further, in the embodiment, the rotating body 74 is provided with the press-down portion 75. Accordingly, the power can be easily transmitted from the head movement motor 101 to the first moving unit 65, the second moving unit 70, and the third moving unit 73. In addition, since it is not necessary to individually transmit the power from the head movement motor 101 to the first moving unit 65, the second moving unit 70, and the third moving unit 73, the number of parts can be reduced. As a result, an increase in cost of the printer 1 can be prevented, and the size of the printer 1 can be reduced.

However, the press-down portion 75 may be formed separately from the rotating body 74.

In addition, in the embodiment, the pinion 72 has the first phase region Ak1 in which a part of the teeth are missing, and when the first phase region Ak1 faces the rack 71, the cam 66 supports the line head 40. Accordingly, the following operational effects can be obtained.

That is, when the first moving unit 65 moves the line head 40, once the second moving unit 70 attempts to move the line head 40, there is a concern that the position adjustment of the line head 40 by the first moving unit 65 is disturbed. According to the embodiment, since the pinion 72 has the first phase region Ak1 in which a part of the teeth are missing, and the cam 66 supports the line head 40 when the first phase region Ak1 faces the rack 71, the second moving unit 70 can be prevented from causing an adverse influence when the first moving unit 65 attempts to move the line head 40.

In addition, in the embodiment, when the movement of the line head 40 by the cam 66 transitions to the movement of the line head 40 by the pinion 72, and when the movement of the line head 40 by the pinion 72 transitions to the movement of the line head 40 by the cam 66, the state where the cam 66 is in contact with the line head 40 and the pinion 72 meshes with the rack 71 is temporarily formed. Accordingly, a state where the line head 40 is supported by neither the cam 66 nor the pinion 72 can be eliminated. As a result, it is possible to avoid the occurrence of a defect in which the line head 40 falls down and the line head 40 is damaged due to an impact. Note that, the state where the cam 66 is in contact with the line head 40 and the pinion 72 meshes with the rack 71 deviates from the states at the first head position, the second head position, and the third head position described above.

In addition, when the cam 66 and the pinion 72 are separately formed, there is a concern that the state where the cam 66 is in contact with the line head 40 and the pinion 72 meshes with the rack 71 cannot be temporarily formed due to a part tolerance, an assembly error, or the like. However, in the embodiment, since the cam 66 and the pinion 72 are integrally formed, it is possible to prevent the occurrence of the above problems.

In addition, in the embodiment, the line head 40 includes the rack member 32 in which the contact portion 32a that comes into contact with the cam 66 and the rack 71 are integrally formed. Accordingly, the positional relationship between the contact portion 32a and the rack 71 is easily determined.

Here, in the case where the contact portion 32a and the rack 71 are separately formed, there is a concern that the state where the cam 66 is in contact with the line head 40 and the pinion 72 meshes with the rack 71 cannot be temporarily formed due to a part tolerance, an assembly error, or the like. However, since the contact portion 32a and the rack 71 are integrally formed and the positional relationship between the contact portion 32a and the rack 71 is easily determined, it is possible to prevent the occurrence of the above problems.

In addition, in the embodiment, the printer 1 includes the guide frame 33 which guides the line head 40 in the X-axis direction, that is, the movement direction of the line head 40, and the shaft 77 which is a rotation axis of the rotating body 74, and the shaft 77 is rotatably supported by the guide frame 33. Accordingly, the positional relationship between the rotating body 74 and the rack member 32 is easily determined, the positional relationship between the rack 71 and the pinion 72 is appropriately determined, and the positional relationship between the contact portion 32a and the cam 66 is also appropriately determined. Therefore, the line head 40 can be appropriately moved by the first moving unit 65 and the second moving unit 70.

In addition, in the embodiment, the head unit 30 includes the plurality of nozzles 44 for ejecting an ink, which is an example of the liquid, along the medium width direction, and includes the line head 40, which is a liquid ejection head that ejects the ink from the nozzles 44 without moving in the medium width direction. The cap portion 61 that covers the head surface 42a, which is a liquid ejection surface of the line head 40, is provided at a position facing the line head 40.

The cap portion 61 is displaceable in a direction advancing and retracting with respect to the line head 40, and the cap portion 61 is pressed toward the line head 40 by the cap spring 63, which is an example of the pressing member.

The line head 40 is further movable from the first region Am1 toward the cap position Hp0 at which the head surface 42a is covered with the cap portion 61.

The rotating body 74 is provided with the press-down portion 75 that presses down the line head 40 toward the cap portion 61 along with the rotation of the rotating body 74 after the contact between the contact portion 32a that comes into contact with the cam 66 in the line head 40 and the cam 66 is released. Accordingly, the following operational effects can be obtained.

In order to reliably cover the head surface 42a of the line head 40 with the cap portion 61, it is necessary to press the head surface 42a firmly against the cap portion 61 against the pressing force from the cap spring 63. The first moving unit 65 moves the line head 40 in the first region Am1 and moves the line head 40 by the rotation of the cam 66, but cannot press the head surface 42a to the cap portion 61.

However, the rotating body 74 is provided with the press-down portion 75 that presses down the line head 40 toward the cap portion 61 along with the rotation of the rotating body 74 after the contact between the contact portion 32a that comes into contact with the cam 66 in the line head 40 and the cam 66 is released. Accordingly, the head surface 42a can be reliably pressed to the cap portion 61, and the head surface 42a can be reliably covered with the cap portion 61.

In addition, since the press-down portion 75 is provided in the rotating body 74, a separate power source for reliably pressing the head surface 42a to the cap portion 61 is not required. As a result, an increase in cost of the printer 1 can be prevented, and the size of the printer 1 can be reduced.

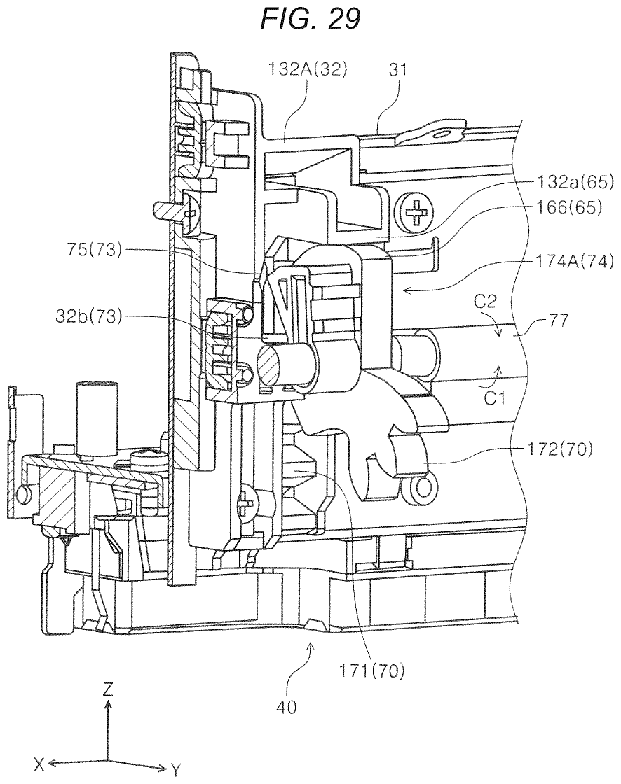

Note that, the rotating body 74A may be formed similarly to a rotating body 174A shown in FIG. 29. Note that, in FIG. 29, the elements already described are denoted by the same reference numerals, and redundant description will be avoided below.

The rotating body 174A includes the press-down portion 75, a cam 166, and a pinion 172. The cam 166 is a modification of the cam 66 described above, and the pinion 172 is a modification of the pinion 72 described above.

In the rotating body 174A according to the embodiment, the cam 166 and the pinion 172 overlap in an axial direction, that is, the X-axis direction. In other words, at least a part of the cam 166 and at least a part of the pinion 172 are at the same position in the X-axis direction. In further other words, the cam 166 and the pinion 172 are disposed along a circumferential direction of the rotating body 174A.

With such a configuration, a size of the rotating body 174A in the X-axis direction can be reduced, and thus the size of the printer 1 can be reduced.

In addition, in the embodiment, a thickness of the cam 166 and a thickness of the pinion 172 in the X-axis direction are the same, and a formation region of the cam 166 and a formation region of the pinion 172 coincide with each other in the X-axis direction. Accordingly, the size of the rotating body 174A in the X-axis direction can be further reduced, and thus the size of the printer 1 can be further reduced.

However, a part of the cam 166 and a part of the pinion 172 may overlap in the X-axis direction. In addition, the thickness of the cam 166 may be different from the thickness of the pinion 172.

In addition, the rack member 32A described above may be formed similarly to a rack member 132A shown in FIG. 29. The rack member 132A includes a contact portion 132a and a rack 171. The contact portion 132a is a modification of the contact portion 32a described above, and the rack 171 is a modification of the rack 71 described above.

The contact portion 132a and the rack 171 overlap in the X-axis direction so as to correspond to the disposition of the cam 166 and the pinion 172. In other words, at least a part of the contact portion 132a and at least a part of the rack 171 are at the same position in the X-axis direction. With such a configuration, a size of the rack member 132A in the X-axis direction can be prevented, and thus the size of the printer 1 can be reduced.

Note that, the configurations of the rotating body 174A and the rack member 132A described above can also be applied to a rotating body (not shown) and a rack member (not shown) positioned in the −X direction.

Note that, in the embodiment, similar to the above embodiment, when the cam drive by the first moving unit 65 transitions to the rack and pinion drive by the second moving unit 70, a state where the cam 166 is in contact with the contact portion 132a and the pinion 172 meshes with the rack 171 is temporarily formed. Accordingly, even when the contact portion 132a is separated from the cam 166, the line head 40 is not thus lowered.

In addition, when the rack and pinion drive by the second moving unit 70 transitions to the cam drive by the first moving unit 65, the state where the cam 166 is in contact with the contact portion 132a, that is, the line head 40, and the pinion 172 meshes with the rack 171 is temporarily formed. Accordingly, even when the pinion 172 is separated from the rack 171, the line head 40 is not thus lowered.

### Position Detection of Line Head

Next, position detection in the movement direction of the line head 40 will be described. Hereinafter, when simply referred to as a movement direction, it means the movement direction (Z-axis direction) of the line head 40.

First, the control unit 100 will be further described with reference to FIG. 4. Note that, the control unit 100 controls the entire printer 1, but a configuration not related to the movement of the line head 40 is not shown in FIG. 4.

The control unit 100 performs various types of control including recording control on the printer 1. The control unit 100 includes one or more processors that operate according to a computer program, in other words, software. The processor includes a CPU and a memory such as a RAM and a ROM, and the memory stores program codes or commands for causing the CPU to execute processing. The control unit 100 is not limited to performing software processing. For example, the control unit 100 may include a dedicated hardware circuit (for example, an application specific integrated circuit: ASIC) that performs hardware processing for at least part of processing execute by itself.

The head movement motor 101 is electrically coupled to the control unit 100 as an output system. In the embodiment, the head movement motor 101 is a DC motor, and is subjected to pulse width modulation (PWM) control by the control unit 100.

In addition, an operation unit 115, the rotary ENC 103, and the linear ENC 107 are electrically coupled to the control unit 100 as an input system. The operation unit 115 is a part that receives ON/OFF of the power supply of the printer 1, various settings, and recording execution, and can be implemented by, for example, a touch panel in which a user interface is implemented by control of the control unit 100.

The control unit 100 includes a calculation unit 120, a motor control unit 121, a motor driver 122, a volatile memory 123, and a nonvolatile memory 124, which is an example of a storage unit.

The calculation unit 120 performs various calculations necessary for operating the printer 1. For example, the calculation unit 120 calculates various setting values necessary for executing a program 125 stored in the nonvolatile memory 124. The volatile memory 123 is used as a temporary data saving region.

The motor control unit 121 controls the head movement motor 101 via the motor driver 122 by outputting, to the motor driver 122, a current command value, for example, a duty signal necessary for pulse width modulation (PWM) control. The motor driver 122 includes a D/A converter, and controls a current supplied to the head movement motor 101 by performing PWM control based on the duty signal.

In the embodiment, the motor control unit 121 performs PID control on the head movement motor 101. The motor control unit 121 calculates a target rotation speed by multiplying, by a gain Kp, a position deviation between a target rotation position of the head movement motor 101 and an actual rotation position obtained from an output signal from the rotary ENC 103. Then, the motor control unit 121 calculates a proportional component, an integral component, and a differential component using a proportional element, an integral element, and a differential element based on a speed deviation between a target rotation speed and an actual rotation speed obtained from an output from the rotary ENC 103, and sends a duty signal to the motor driver 122 based on a sum of the calculation results.

Note that, the motor control unit 121 may control the head movement motor 101 based on an output signal from the linear ENC 107 instead of the output signal from the rotary ENC 103.

The calculation unit 120 detects an edge of an output pulse of the rotary ENC 103, counts the number thereof, and calculates the rotation position of the head movement motor 101 based on the count value. The calculation unit 120 distinguishes forward rotation and reverse rotation of the head movement motor 101 based on comparison processing of two pulse signals output from the rotary ENC 103. Then, when one edge is detected, the calculation unit 120 performs counting processing so as to perform increment and decrement of the rotation position of the head movement motor 101 according to the forward rotation and the reverse rotation.

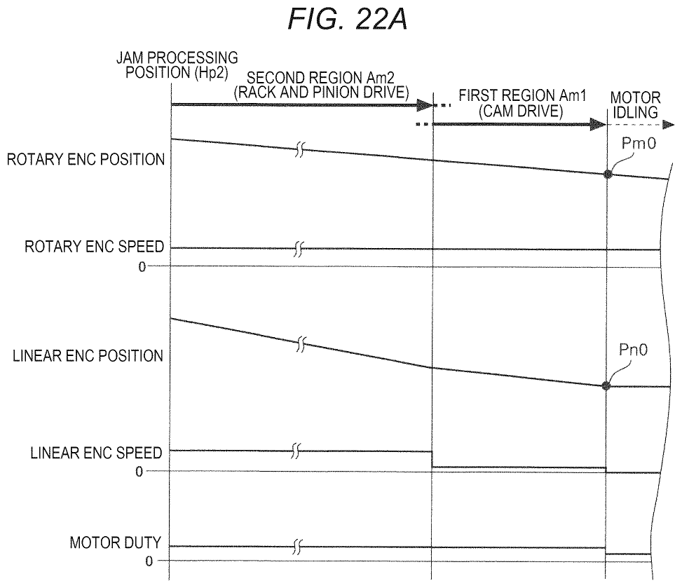

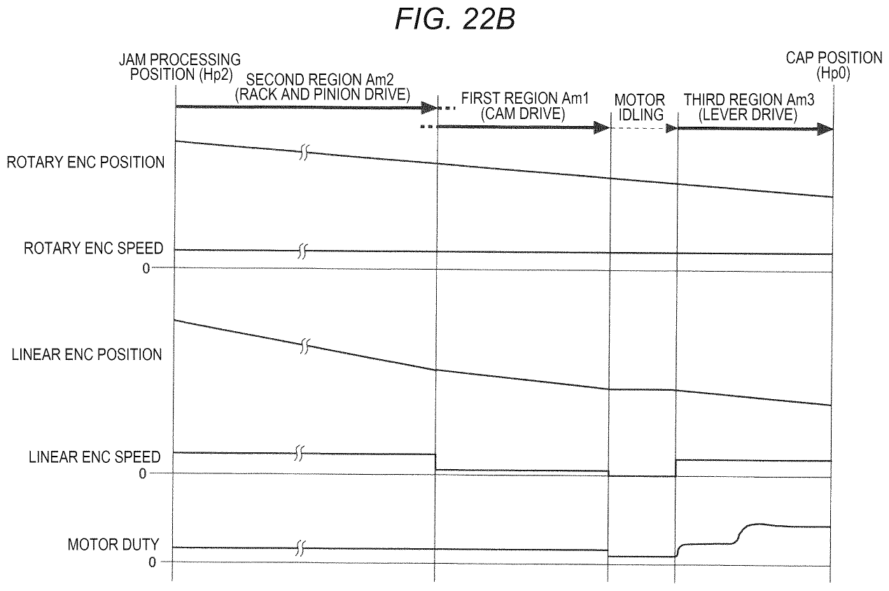

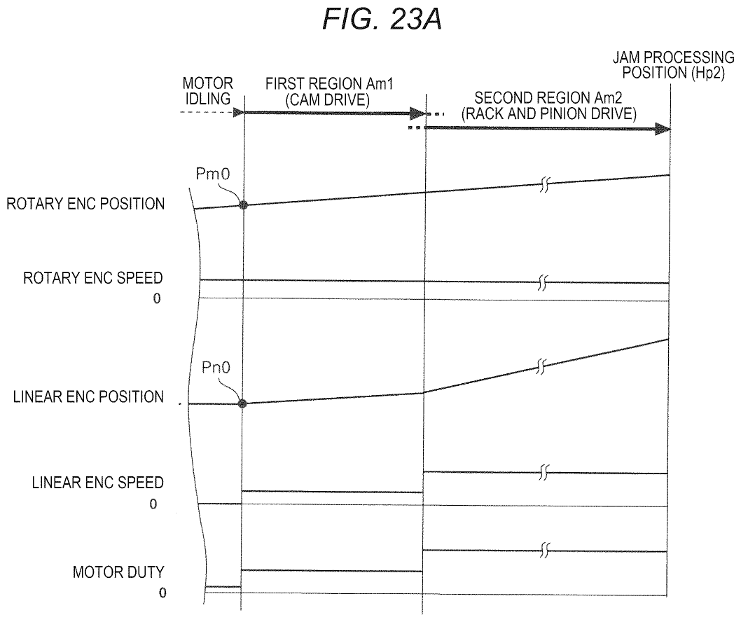

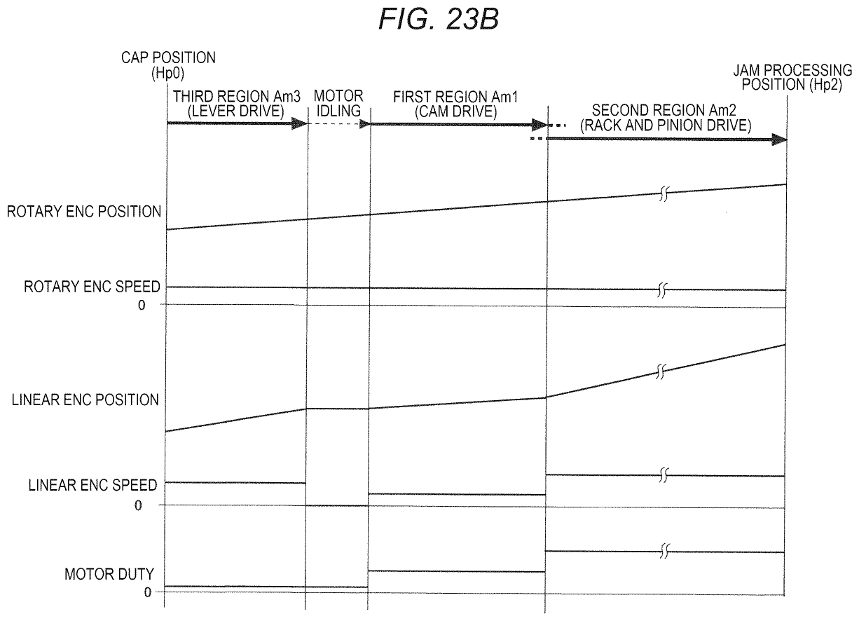

In a “rotary ENC position” shown in FIGS. 22A, 22B, 23A, and 23B, a vertical axis is the rotation position of the head movement motor 101 obtained by the counting processing, an upward direction is an increment direction, that is, a raising direction of the line head 40, and a downward direction is a decrement direction, that is, a lowering direction of the line head 40.

Note that, the rotary ENC 103 outputs two pulse signals, i.e., a pulse ENC-A and a pulse ENC-B. In both cases of the forward rotation and the reverse rotation of the head movement motor 101, the phases of the pulse ENC-A and the pulse ENC-B are shifted by 90 degrees. When the head movement motor 101 is in the forward rotation, the pulse ENC-A is advanced in phase by 90 degrees from the pulse ENC-B. On the other hand, when the head movement motor 101 is in the reverse rotation, the pulse ENC-A is delayed in phase by 90 degrees from the pulse ENC-B. A duration of one cycle of each pulse is equal to a duration it takes for the head movement motor 101 to rotate by a gap between slits of the rotary scale 104. Accordingly, the calculation unit 120 can detect the rotation speed of the head movement motor 101. A “rotary ENC speed” shown in FIGS. 22A, 22B, 23A, and 23B corresponds to the rotation speed.

Note that, the calculation unit 120 can calculate the movement amount of the line head 40 based on a rotation amount of the head movement motor 101 and the speed reduction ratio of the speed reduction mechanism 76 described above. In addition, when the calculation unit 120 detects the duration of one cycle of each pulse, a movement speed of the line head 40 can be calculated based on the speed reduction ratio of the speed reduction mechanism 76 described above. However, when no signal change of the linear ENC 107 is detected, that is, when a linear ENC position to be described later does not change, the line head 40 does not move even when the position of the rotary ENC 103 changes.

In addition, the calculation unit 120 may also detect edges of an output pulse of the linear ENC 107, count the number thereof, and calculate the position of the line head 40 in the movement direction based on the count value. The calculation unit 120 distinguishes the raising and the lowering of the line head 40 based on comparison processing of two pulse signals output from the linear ENC 107. Then, when one edge is detected, the calculation unit 120 performs counting processing so as to perform increment and decrement of the position of the line head 40 according to the raising and the lowering.

In a “linear ENC position” shown in FIGS. 22A, 22B, 23A, and 23B, the vertical axis is the position obtained by the counting processing, and corresponds to the position of the line head 40 in the movement direction. In the linear ENC position, the upward direction is the increment direction, that is, the raising direction of the line head 40, and the downward direction is the decrement direction, that is, the lowering direction of the line head 40.

Note that, the linear ENC 107 outputs two pulse signals, i.e., a pulse ENC-A and a pulse ENC-B. In both cases of the raising and the lowering of the line head 40, the phases of the pulse ENC-A and the pulse ENC-B are shifted by 90 degrees. When the line head 40 is raised, the pulse ENC-A is advanced in phase by 90 degrees from the pulse ENC-B. On the other hand, when the line head 40 is lowered, the pulse ENC-A is delayed in phase by 90 degrees from the pulse ENC-B. A duration of one cycle of each pulse is equal to a duration for the line head 40 to move by a gap between slits of the linear scale 108.

When the calculation unit 120 counts the number of pulse signals, the movement amount of the line head 40 can be detected. In addition, when the calculation unit 120 detects the duration of one cycle of each pulse, the movement speed of the line head 40 can be calculated. A “linear ENC speed” shown in FIGS. 22A, 22B, 23A, and 23B corresponds to the movement speed.

Hereinafter, an outline of a method of detecting an origin of the line head 40 will be described.

The origin of the line head 40 is detected in a state where the shutter 47 is closed. As an example, in the case of lowering the line head 40 from the recording position Hp1 shown in FIG. 19, both the rotary ENC 103 and the linear ENC 107 have a signal change until the protruding portion 55 provided on the line head 40 comes into contact with the facing portion 45. This is reflected in the rotary ENC position and the linear ENC position during a cam drive period shown in FIG. 22A.

When the protruding portion 55 comes into contact with the facing portion 45 by lowering the line head 40, the lowering of the line head 40 is temporarily stopped, and thus the linear ENC 107 has no signal change. This is reflected in the linear ENC position in a motor idling period shown in FIG. 22A. However, since the head movement motor 101 continuously rotates, the rotary ENC 103 continuously has a signal change as shown in the rotary ENC position in the motor idling period shown in FIG. 22A.

The control unit 100 can set an origin position of the line head 40 using this property. That is, the control unit 100 sets the origin position of the line head 40 based on the position of the line head 40 when the linear ENC 107 has no signal change in a state where the rotary ENC 103 has a signal change in lowering the line head 40 toward the facing portion 45.

In FIG. 22A, a position Pm0 is the rotary ENC position at a time when the linear ENC 107 has no signal change, that is, an origin position of the rotary ENC 103, and a position Pn0 is the linear ENC position at a time when the linear ENC 107 has no signal change, that is, an origin position of the linear ENC 107.

The position of the line head 40 in the movement direction may be grasped based on the origin position of the rotary ENC 103 or may be grasped based on the origin position of the linear ENC 107. In any case, a distance from the origin position to a boundary of respective regions can be stored in the nonvolatile memory 124 as a known value. As a result, the control unit 100 can grasp a current position of the line head 40.

Note that, in the embodiment, an encoder resolution with respect to a unit movement amount of the line head 40 by the speed reduction mechanism 76 is higher in the rotary ENC 103 than in the linear ENC 107. Therefore, in order to ensure stop position accuracy of the line head 40, it is suitable to perform basic speed control on the head movement motor 101 based on the output signal from the rotary ENC 103.

Note that, in the case of raising the line head 40, the origin position of the line head 40 can be set. For example, in the case of raising the line head 40 from a state in a motor idling period in FIG. 23A, when the cam 66 comes into contact with the contact portion 32a and lifts the line head 40, the protruding portion 55 is separated from the facing portion 45, and the line head 40 is raised. This is reflected in the linear ENC position when transitioning from the motor idling period to a cam drive period shown in FIG. 23A.

The control unit 100 can set the origin position of the line head 40 using this property. That is, the control unit 100 can set the origin position of the line head 40 based on the position of the line head 40 when the linear ENC 107 has a signal change in the state where the rotary ENC 103 has a signal change.

In this manner, since the control unit 100 sets the origin position based on that the line head 40 has no position change based on the linear ENC 107 during the driving of the head movement motor 101, the origin position can be appropriately set.

Note that, FIG. 22B shows an example of a case where the line head 40 is lowered from the jam processing position Hp2 to the cap position Hp0, and FIG. 23B shows an example of a case where the line head 40 is raised from the cap position Hp0 to the jam processing position Hp2 in a state where the shutter 47 is open. Note that, in a configuration in which the line head 40 is supported by the upstream support portion 46 in the state where the shutter 47 is open, the origin position of the line head 40 may be set in lowering the line head 40 or the origin position of the line head 40 may be set in raising the line head 40 in the state where the shutter 47 is open.

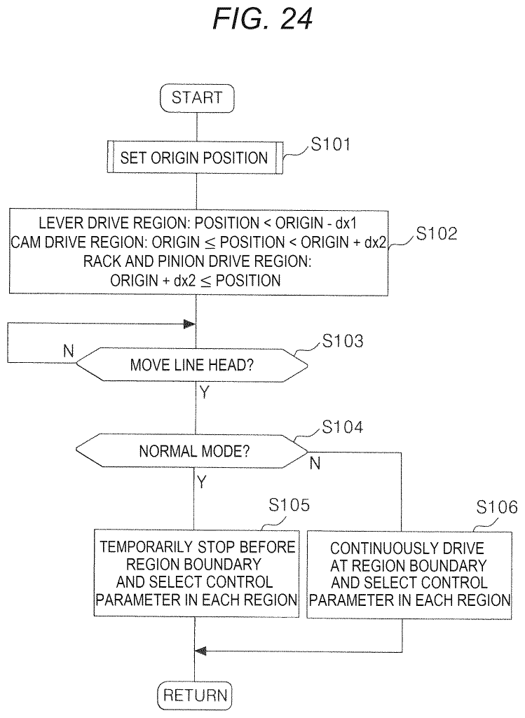

Hereinafter, the processing executed by the control unit 100 will be further described with reference to FIG. 24.

The control unit 100 performs origin position setting on the line head 40 described above at a predetermined timing (step S101). This origin position setting can be performed when the power supply of the printer 1 is turned on, when an elapsed time from the previous origin position setting is longer than a predetermined time, or the like.

Next, the control unit 100 sets the rotary ENC position, as shown in step S102. Note that, the position in step S102 is the rotary ENC position, but may be the linear ENC position.

Accordingly, the rotary ENC position in a lever drive region is set to “position <origin−dx1”. The distance dx1 is a distance from the origin position to the lever drive region.

In addition, the rotary ENC position in a cam drive region is set to “origin≤position<origin+dx2”. The distance dx2 is a distance from the origin position to a rack and pinion drive region.

In addition, the rotary ENC position in the rack and pinion drive region is set to the “origin+dx2≤position”. The distances dx1 and dx2 are saved in the nonvolatile memory 124 as a part of control parameters 126 (see FIG. 4).

Note that, lengths of the lever drive region and the rack and pinion drive region are also saved in the nonvolatile memory 124 as a part of the control parameters 126 (see FIG. 4).

Next, in the case of moving the line head 40 (Yes in step S103), the control unit 100 determines whether a print mode is a normal mode (step S104). A user can select the normal mode or a speed priority mode as the print mode via the operation unit 115.

In the case of the normal mode, the control unit 100 temporarily stops the line head 40 before a region boundary and selects the control parameter in each region (step S105). In the case of the speed priority mode, the control unit 100 continuously drives without stopping the line head 40 at the region boundary, and selects the control parameter in each region (step S106).

The control parameter in each region is saved in the nonvolatile memory 124 as a part of the control parameters 126 (see FIG. 4). The control parameter in each region includes a torque limit value of the head movement motor 101. The torque limit value is, for example, a limit value of a duty signal to be sent to the motor driver 122, thereby limiting a drive current value of the head movement motor 101. The torque limit value for each region is saved in the nonvolatile memory 124 as a part of the control parameters 126 (see FIG. 4). By setting the torque limit value, an excessive load is prevented from being applied to the drive mechanism when an abnormality occurs.

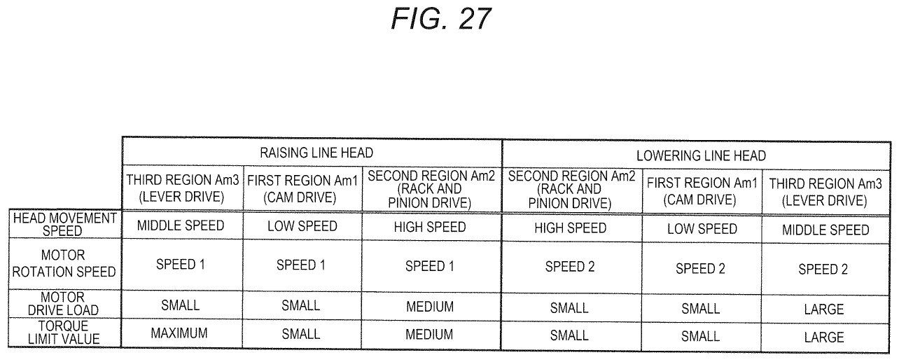

FIG. 27 shows the head movement speed, the motor rotation speed, the motor drive load, and the torque limit value for each region in the cases of raising and lowering the line head 40.

In the case of lowering the line head 40, the head movement speed is the lowest in the first region Am1, that is, in the case of the cam drive, is the highest in the second region Am2, that is, in the case of the rack and pinion drive, and is the intermediate in the third region Am3, that is, in the case of the lever drive. In addition, in the case of lowering the line head 40, the motor rotation speed is speed 2 in each region. However, for example, in order to reduce an impact when the line head 40 comes into contact with an obstacle in the second region Am2 or the third region Am3, the speed may be set to be lower than the speed 2.

In addition, in the case of lowering the line head 40, the drive load of the head movement motor 101 is the smallest in the first region Am1 and the second region Am2, and is larger in the third region Am3 than in the first region Am1 and the second region Am2. Therefore, in the case of lowering the line head 40, the torque limit value is the smallest in the first region Am1 and the second region Am2, and is larger in the third region Am3 than in the first region Am1 and the second region Am2. In the third region Am3, the press-down portion 75 presses down the line head 40 against the spring force from the coil spring 54 (see FIG. 20) or the cap spring 63 (see FIG. 20). This is reflected in a motor duty in the lever drive region shown in FIG. 22B. In the case of lowering the line head 40, in the third region Am3, the head movement motor 101 first receives a load from the coil spring 54, and then receives a load from both the coil spring 54 and the cap spring 63. Therefore, the motor duty increases as the line head 40 is lowered. Therefore, the torque limit value is the largest in the third region Am3.

Next, in the case of raising the line head 40, the head movement speed is the lowest in the first region Am1, that is, in the case of the cam drive, is the highest in the second region Am2, that is, in the case of the rack and pinion drive, and is the intermediate in the third region Am3, that is, in the case of the lever drive. In addition, in the case of raising the line head 40, the motor rotation speed is speed 1 in each region. However, for example, in order to reduce an impact when the line head 40 comes into contact with an obstacle in the second region Am2 or the third region Am3, the speed may be set to be lower than the speed 1. Note that, the speed 1 may be equal to the speed 2, may be higher than the speed 2, or may be lower than the speed 2.

In addition, in the case of raising the line head 40, the drive load of the head movement motor 101 is the smallest in the third region Am3 and the first region Am1, and is larger in the second region Am2 than in the first region Am1 and the third region Am3. However, in the case of raising the line head 40, the torque limit value is the largest in the third region Am3. This is because, in the case where the worm gear mechanism is caught during the head lowering, there is a concern that a motor drive load larger than the motor drive load during the head lowering is applied during the head raising. Note that, the torque limit value is the smallest in the first region Am1 and is larger in the second region Am2 than in the first region Am1.

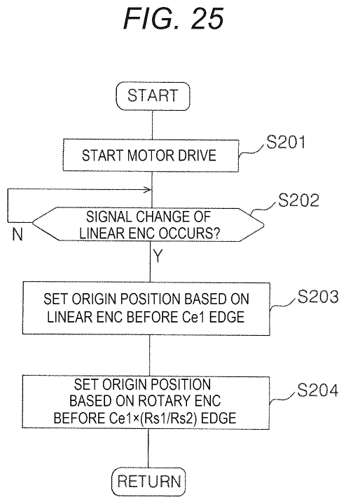

Next, processing of raising the line head 40 from a state where the line head 40 is placed on the facing portion 45 via the protruding portion 55 and detecting the origin of the line head 40 will be described with reference to FIG. 25.

The control unit 100 starts driving the head movement motor 101 so as to raise the line head 40 in the state where the line head 40 is placed on the facing portion 45 via the protruding portion 55 (step S201). Next, in the case where the linear ENC 107 has a signal change (Yes in step S202), when the number of edges of the output pulse of the linear ENC 107 is Ce1, an origin position based on the linear ENC 107 is set before a Ce1 edge (step S203). An example of the edge number Ce1 is 1.

Next, the control unit 100 sets an origin position based on the rotary ENC 103 before a Ce1×(Rs1/Rs2) edge (step S204). Here, Rs1 is the resolution of the rotary ENC 103, specifically, the number of edges of the output pulse of the rotary ENC 103 with respect to the unit movement amount of the line head 40. In addition, Rs2 is the resolution of the linear ENC 107, specifically, the number of edges of the output pulse of the linear ENC 107 with respect to the unit movement amount of the line head 40.

By setting the origin position of the line head 40 in this manner, the origin position of the line head 40 can be accurately set.

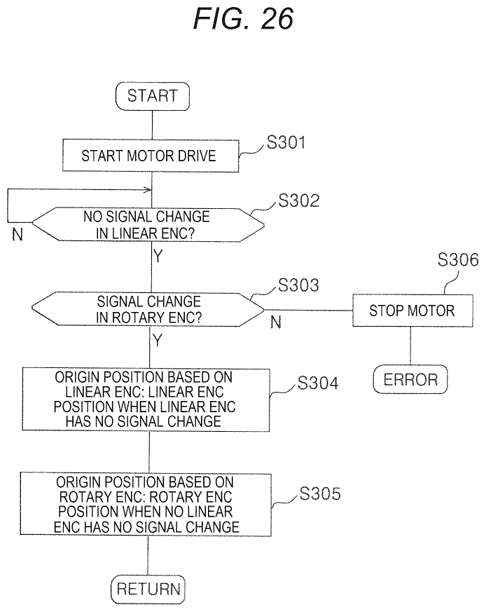

Next, processing of lowering the line head 40 from a state where the protruding portion 55 of the line head 40 is separated from the facing portion 45 and detecting the origin of the line head 40 will be described with reference to FIG. 26.

The control unit 100 starts driving the head movement motor 101 so as to lower the line head 40 (step S301). Next, in the case where the linear ENC 107 has no signal change (Yes in step S302), when the rotary ENC 103 has a signal change (Yes in step S303), the origin position based on the linear ENC 107 is set to the linear ENC position at the time when the linear ENC 107 has no signal change (step S304). In addition, the control unit 100 sets the origin position based on the rotary ENC 103 to the rotary ENC position at the time when the linear ENC 107 has no signal change (step S305).

By setting the origin position of the line head 40 in this manner, the origin position of the line head 40 can be accurately set.

The origin position setting in step S101 in FIG. 24 may be the processing shown in FIG. 25 or the processing shown in FIG. 26.

Note that, when the linear ENC 107 has no signal change (Yes in step S302) and when the rotary ENC 103 has no signal change (No in step S303) even though the line head 40 is within the movement region, it is determined that the head unit 30 comes into contact with some obstacle, the head movement motor 101 is stopped (step S306), and error processing is performed. As an example of the error processing, an alert indicating that an abnormality has occurred is displayed on the operation unit 115.

Accordingly, it is possible to prevent an excessive load from being applied to the line head 40 or the moving unit 110, and to prevent damage to the line head 40 or the moving unit 110.

Note that, the moving unit 110 has a backlash such as a gear backlash. Therefore, in particular, in the case of raising the line head 40 after the origin position of the line head 40 is set while lowering the line head 40, and in the case of raising the line head 40 based on the origin position of the rotary ENC 103, it is suitable to set a target stop position of the head movement motor 101 in consideration of the backlash.

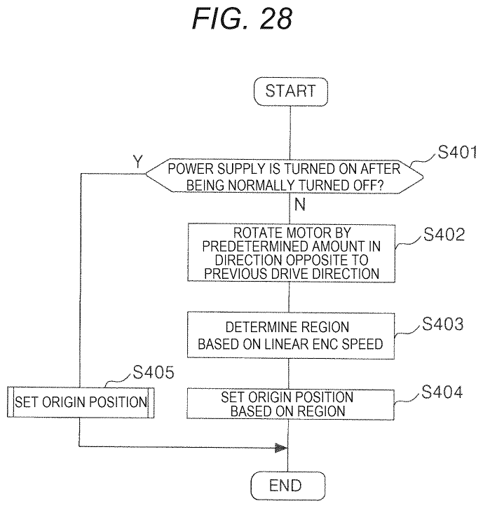

Next, processing when the power supply of the printer 1 is not turned off in a normal procedure will be described with reference to FIG. 28. When the power supply of the printer 1 is turned off in a normal procedure, specifically, when the user presses a power button (not shown) to turn off the power supply, the line head 40 is moved to the cap position. Therefore, in this case, when the power supply of the printer 1 is turned on, the control unit 100 can determine that the line head 40 is at the cap position. However, in the case where the power supply of the printer 1 is not turned off in a normal procedure, for example, in the case where a power cord is pulled out in a state where the power supply is on, when the power supply of the printer 1 is turned on thereafter, the control unit 100 cannot grasp the accurate current position of the line head 40. Therefore, in this case, exception processing for grasping the current position of the line head 40 is required.

Note that, it is also possible to grasp the position of the line head 40 by abutting the line head 40 against one end portion or the other end portion of the movement region and detecting an increase in drive current value of the head movement motor 101 at this time. However, this method is not preferred since there is a concern that an excessive surface pressure is generated between the worm wheel 83 (see FIG. 9) and the cylindrical worm 84 (see FIG. 9) constituting the worm gear mechanism to cause locking.

Note that, whether the power supply of the printer 1 is turned off in a normal procedure can be determined by saving, in the nonvolatile memory 124 (see FIG. 4), a power supply flag indicating that the power supply of the printer 1 is turned off in a normal procedure when the power supply of the printer 1 is turned off in a normal procedure. For example, when the power supply of the printer 1 is turned off in a normal procedure, the control unit 100 saves “1” as the power supply flag in the nonvolatile memory 124. Then, the control unit 100 reads the power supply flag when the power supply of the printer 1 is turned on, and performs the origin position setting in a normal procedure when the power supply flag is “1” (step S101 in FIG. 24). At this time, the power supply flag is reset to “0”.

When the power supply of the printer 1 is turned on, the control unit 100 reads the power supply flag, and when the power supply flag is “0”, the control unit 100 determines that the power of the printer 1 is not turned off in a normal procedure, and performs the exception processing shown in FIG. 28.

In FIG. 28, when the power supply of the printer 1 is turned on, the control unit 100 determines whether the power supply is turned on after being normally turned off (step S401). When the power supply is turned on after being normally turned off (Yes in step S401), the normal origin position setting is performed (step S405). Note that, the processing in step S405 is the same as that in step S101 in FIG. 24.

When the power supply is not turned on after being normally turned off (No in step S401), the control unit 100 drives the head movement motor 101 by a predetermined amount in a direction opposite to the previous drive direction (step S402).

Here, the previous drive direction is a drive direction when the control unit 100 previously drives the head movement motor 101. The control unit 100 saves, in the nonvolatile memory 124 (see FIG. 4), a direction flag indicating the rotation direction each time the head movement motor 101 is driven. By reading the direction flag, the control unit 100 can grasp the rotation direction when the head movement motor 101 is driven previously.

In addition, the “predetermined amount” in step S402 is preferably as small as possible within a range in which the linear ENC speed can be detected. For example, the “predetermined amount” is preferably 5.0 mm or less and more preferably 3.0 mm or less in terms of the movement amount of the line head 40. The “predetermined amount” is saved in the nonvolatile memory 124 as a part of the control parameters 126 (see FIG. 4). By minimizing the “predetermined amount” in this manner, it is possible to prevent the line head 40 from coming into contact with some obstacle when the line head 40 is moved, and to prevent the worm gear mechanism described above from being locked.

Next, the control unit 100 determines which region the line head 40 is currently in based on the linear ENC speed (step S403). As described with reference to FIG. 27, the movement speed of the line head 40, that is, the linear ENC speed is different in each of the first region Am1, the second region Am2, and the third region Am3. That is, the linear ENC speed when the head movement motor 101 is rotated at a predetermined rotation speed is different in respective regions and can be acquired as a known value. Therefore, the control unit 100 can determine which region the line head 40 is in based on the linear ENC speed. Of course, if the linear ENC speed when the head movement motor 101 is rotated at a predetermined rotation speed is zero, it can be determined that the line head 40 is in a motor idling region in FIGS. 22A and 23A. The movement speed of the line head 40 in each region when the head movement motor 101 is rotated at a predetermined rotation speed is saved in the nonvolatile memory 124 as a part of the control parameters 126 (see FIG. 4). Of course, the movement speed is a value having a width in consideration of an error.

When it is possible to determine which region the line head 40 is in, it is possible to determine in which direction the line head 40 should be moved in order to set the origin position. Therefore, the control unit 100 performs origin position setting based on which region the line head 40 is in (step S404). For example, when the line head 40 is in the second region Am2 or the first region Am1, the origin position can be set by lowering the line head 40. When the line head 40 is in the third region Am3 or the motor idling region, the origin position can be set by raising the line head 40. The origin position setting by raising the line head 40 is the processing shown in FIG. 25, and the origin position setting by lowering the line head 40 is the processing shown in FIG. 26.

Note that, in the case where the linear ENC speed is zero when the head movement motor 101 is rotated at a predetermined rotation speed, a case where the line head 40 is in the motor idling region and a case where the line head 40 is in contact with some portion and cannot move are considered. However, in step S402, the head movement motor 101 is driven in the direction opposite to the previous drive direction. Therefore, it is possible to avoid a state where the line head 40 cannot move due to abutting against at least the one end portion or the other end portion of the movement region.

As described above, even when the power supply of the printer 1 is not turned off in a normal procedure, the current position of the line head 40 can be grasped based on detection information of the rotary ENC 103 and the linear ENC 107. Further, at this time, the occurrence of locking of the worm gear mechanism described above can be prevented.

Note that, in the above embodiment, the control unit 100 determines which region the line head 40 is currently in based on the linear ENC speed, but instead of the linear ENC speed, the motor drive load, specifically, a motor drive current value may be adopted. This is because the motor drive load, that is, the motor drive current value is different in respective regions.

Note that, when the shutter 47 (see FIG. 5) is closed, the line head 40 is in the first region Am1 or the second region Am2. Therefore, when a sensor that detects a position of the shutter 47 is provided, the position of the line head 40 may be grasped with reference to the position of the shutter 47.

When a sensor that detects that the cap unit 60 is at a lowered position is provided, the position of the line head 40 may be grasped with reference to a state of the sensor. For example, when the cap unit 60 is not at the lowered position, the line head 40 is lowered. Accordingly, after the lowered position of the cap unit 60 is detected, it can be determined that the line head 40 is at the cap position.

Hereinafter, the operational effects of the printer 1 configured as described above will be described. First, as described above, the movement direction of the line head 40 includes the vertically downward component. The position detection unit for detecting the position of the line head 40 with respect to the medium conveyance path Ta is the linear ENC 107 including the linear scale 108 provided along the movement direction of the line head 40 and the first detection unit 109 that is a detection unit provided in the line head 40 and that detects the linear scale 108.

The moving unit 110 for moving the line head 40 by receiving the power from the head movement motor 101 has a configuration of allowing the head movement motor 101 to idle after the line head 40 is placed on the facing portion 45 by using its own weight in the case of lowering the line head 40 toward the facing portion 45. The idling of the head movement motor 101 corresponds to the rotation of the head movement motor 101 in the motor idling region shown in FIGS. 22A and 23A. That is, the idling of the head movement motor 101 means a state where the rotation of the head movement motor 101 is not converted into the movement of the line head 40 and the head movement motor 101 does not receive a load from the line head 40.

Then, the control unit 100 grasps the position of the line head 40 in the movement direction based on a change in detection signal from the linear ENC 107 when the line head 40 is placed on the facing portion 45 during the lowering of the line head 40 (the linear ENC position Pn0 in FIG. 22A) or a change in detection signal from the linear ENC 107 in raising the line head 40 from the state of being placed on the facing portion 45 (the linear ENC position Pn0 in FIG. 23A).

Accordingly, the position of the line head 40 with respect to the facing portion 45 can be appropriately grasped, and thus the platen gap can be appropriately set. In addition, the line head 40 can be appropriately positioned at the cap position Hp0 or the jam processing position Hp2.

In addition, since the platen gap can be set with high accuracy, adjustment in a step of assembling the printer 1 is not required, and the assembly time can be shortened. In addition, even when a part is deformed from an assembled state due to an impact during transportation of the printer 1, a target platen gap is easily obtained.

In addition, even when a member such as a gear constituting the moving unit 110 is worn due to aging deterioration, the platen gap is less likely to be influenced.

In addition, since the moving unit 110 has a configuration of allowing the head movement motor 101 to idle after the line head 40 is placed on the facing portion 45 by using its own weight in the case of lowering the line head 40 toward the facing portion 45, the following operational effects can be obtained.

For example, in the case of a configuration in which the position of the line head 40 in the movement direction is grasped by detecting an increase in drive current value of the head movement motor 101 when the line head 40 comes into contact with the facing portion 45, a load is applied to the moving unit 110, and there is a concern that the part is damaged. In addition, it may be difficult to appropriately set a threshold of the drive current value. In addition, when the moving unit 110 includes the worm gear mechanism (see FIG. 9) as in the embodiment, there is a concern that an excessive surface pressure is generated between the worm wheel 83 and the cylindrical worm 84 to cause locking. However, the moving unit 110 has a configuration of allowing the head movement motor 101 to idle after the line head 40 is placed on the facing portion 45 by using its own weight in the case of lowering the line head 40 toward the facing portion 45. Accordingly, it is possible to prevent the occurrence of the above problems.

In addition, in the embodiment, the rotary ENC 103, which is a rotation detection unit for detecting the rotation of the head movement motor 101, is provided. Then, the control unit 100 grasps the position of the line head 40 in the movement direction based on the detection signal from the linear ENC 107 and the detection signal from the rotary ENC 103. Accordingly, the position of the line head 40 in the movement direction can be accurately grasped.

In addition, in the embodiment, the rotation detection unit is the rotary ENC 103 including the rotary scale 104 provided on the motor output shaft of the head movement motor 101 and the second detection unit 105 for detecting the rotary scale 104. Accordingly, the rotation of the head movement motor 101 can be accurately detected.

In addition, the moving unit 110 includes the cylindrical worm 84 driven by the head movement motor 101, and the worm wheel 83 that meshes with the cylindrical worm 84 and that rotates with the rotation of the cylindrical worm 84. In such a configuration, when an excessive surface pressure is generated between the worm wheel 83 and the cylindrical worm 84 as described above, there is also a concern that locking occurs. However, since the excessive load is not applied to the moving unit 110 when the position of the line head 40 with respect to the facing portion 45 is grasped as described above, the occurrence of the locking can be prevented.

In addition, the worm gear mechanism can increase the speed reduction ratio when the power is transmitted from the head movement motor 101 to the line head 40. As a result, the resolution of the rotary ENC 103 can be made larger than the resolution of the linear ENC 107, and the line head 40 can be accurately positioned with respect to the facing portion 45.

In addition, the control unit 100 sets the origin position of the line head 40 in the movement direction, based on the position of the line head 40 at the time when the linear ENC 107 has no signal change during the rotation of the head movement motor 101 in lowering the line head 40 toward the facing portion 45 (the linear ENC position Pn0 in FIG. 22A), or the position of the line head 40 at the time when the linear ENC 107 has a signal change during the rotation of the head movement motor 101 in raising the line head 40 from the state of being placed on the facing portion 45 (the linear ENC position Pn0 in FIG. 23A).

In other words, the control unit 100 sets the origin position of the line head 40 in the movement direction, based on the position of the line head 40 when the linear ENC 107 has no signal change in the state where the rotary ENC 103 has a signal change in lowering the line head 40 toward the facing portion 45 (the linear ENC position Pn0 in FIG. 22A), or the position of the line head 40 when the linear ENC 107 has a signal change in the state where the rotary ENC 103 has a signal change in raising the line head 40 from the state of being placed on the facing portion 45 (the linear ENC position Pn0 in FIG. 23A).

In addition, a control method implemented by the control unit 100 includes a step of setting the origin position of the line head 40 in the movement direction, based on the position of the line head 40 when the linear ENC 107 has no signal change in the state where the rotary ENC 103 has a signal change in lowering the line head 40 toward the facing portion 45, or the position of the line head 40 when the linear ENC 107 has a signal change in the state where the rotary ENC 103 has a signal change in raising the line head 40 from the state of being placed on the facing portion 45.

Accordingly, the origin of the line head 40 in the movement direction can be appropriately set using the signal change of the linear ENC 107. As a result, positioning accuracy of the line head 40 is improved.

In addition, the line head 40 includes the protruding portion 55 protruding toward the facing portion 45, and when the protruding portion 55 comes into contact with the facing portion 45, the line head 40 is placed on the facing portion 45 by using its own weight. Accordingly, it is possible to avoid contact between the facing portion 45 and a portion of the line head 40 where recording is performed on the medium, specifically, the head chip 43 (see FIG. 2). As a result, the head chip 43 can be prevented from being damaged, and the facing portion 45 can be prevented from being contaminated.

In addition, when a plurality of protruding portions 55 are provided in the medium width direction and the protruding portions 55 are brought into contact with the facing portion 45, the posture of the line head 40 with respect to the facing portion 45 is also appropriately determined.

Therefore, for example, the position of the line head 40 when the protruding portion 55 comes into contact with the facing portion 45 may be set as the first head position. Accordingly, the platen gap can be set extremely appropriately, a parallelism of the line head 40 with respect to the facing portion 45 can also be ensured, and an appropriate recording quality can be obtained.

Note that, in order to grasp the posture of the line head 40 with respect to the facing portion 45, a plurality of linear ENCs 107 may be provided at gaps in the X-axis direction to detect the posture of the line head 40 with respect to the facing portion 45. At this time, in order to correct the posture of the line head 40 with respect to the facing portion 45, in the shaft 77, the rotating body 74A provided near the end portion in the +X direction and the rotating body 74B provided at the end portion in the −X direction may be driven by different motors.

In addition, in the embodiment, the moving unit 110 includes the speed reduction mechanism 76 having a speed reduction ratio larger than 1 when the power is transmitted from the head movement motor 101 to the line head 40. The control unit 100 grasps the position of the line head 40 in the movement direction based on the signal from the linear ENC 107, and controls the head movement motor 101 based on the signal from the rotary ENC 103. In other words, the control method implemented by the control unit 100 includes a step of grasping the position of the line head 40 in the movement direction based on the signal from the linear ENC 107 and controlling the head movement motor 101 based on the signal from the rotary ENC 103.

According to such a configuration, since the movement of the line head 40 is directly detected by the linear ENC 107, the position of the line head 40 can be appropriately grasped. As a result, it is easy to appropriately adjust the gap between the line head 40 and the facing portion 45.

In addition, by referring to the detection signal from the linear ENC 107 during the motor control based on the detection signal from the rotary ENC 103, the position of the line head 40 can be accurately grasped without being influenced by the backlash of the gear constituting the moving unit 110.

Here, since the linear ENC 107 is configured to directly detect the movement of the line head 40, there is a concern that the stop accuracy in stopping the head movement motor 101 cannot be obtained due to the resolution of the linear ENC 107. As a result, there is a concern that the line head 40 cannot be accurately stopped at a desired position. However, in the embodiment, the moving unit 110 includes the speed reduction mechanism 76 having a speed reduction ratio larger than 1 when the power is transmitted from the head movement motor 101 to the line head 40. Therefore, the resolution of the rotary ENC 103 can be ensured. Then, when the head movement motor 101 is controlled based on the signal from the rotary ENC 103, the stop accuracy in stopping the head movement motor 101 can be improved, and it is easy to accurately stop the line head 40 at a desired position.

In addition, the control unit 100 detects each region constituting the movement region based on the origin position of the line head 40 in the movement direction, and controls the head movement motor 101 with a control parameter according to each region. Therefore, the line head 40 can be appropriately positioned using appropriate control according to each region.

In addition, the control parameter in each region includes the torque limit value of the head movement motor 101. Accordingly, the following operational effects can be obtained.

When a load applied to the head movement motor 101 is different in respective regions constituting the movement region of the line head 40, the required motor drive torques are different. Therefore, when a large torque limit value is set for a region where the load is small, an excessive load is applied to the mechanical part when an abnormality occurs, which may cause damage or the like to the mechanical part.

However, since the control parameter includes the torque limit value of the head movement motor 101, it is possible to prevent damage or the like to the mechanical parts described above.

Note that, the control parameter may be another parameter such as the target speed of the head movement motor 101 or the gain Kp of the PID control, or may be any two or more of a plurality of parameters.

In addition, the control unit 100 temporarily stops the head movement motor 101 at a boundary between respective regions constituting the movement region (step S105 in FIG. 24). That is, at the boundary between respective regions constituting the movement region of the line head 40, there is a concern that a collision sound between the members is generated due to the switching of the drive mechanism. However, the generation of the collision sound can be prevented by temporarily stopping the head movement motor 101 at the boundary between respective regions constituting the movement region.

Note that, instead of temporarily stopping the head movement motor 101, the speed of the head movement motor 101 may be reduced.

In addition, the printer 1 includes the operation unit 115, which is an example of a reception unit, that receives selection of either the speed priority mode or the normal mode as a control mode in moving the line head 40. Then, when the speed priority mode is selected, the control unit 100 continuously drives the head movement motor 101 at the boundary between respective regions constituting the movement region (step S106 in FIG. 24). In addition, when the normal mode is selected, the control unit 100 temporarily stops the head movement motor 101 at the boundary between respective regions constituting the movement region (step S105 in FIG. 24).

At the boundary between respective regions constituting the movement region of the line head 40, there is a concern that a collision sound between the members is generated due to the switching of the drive mechanism. However, in the normal mode, since the head movement motor 101 is temporarily stopped at the boundary between respective regions constituting the movement region of the line head 40, the generation of the collision sound described above can be prevented.

In addition, in the speed priority mode, since the head movement motor 101 is continuously driven at the boundary between respective regions constituting the movement region of the line head 40, the throughput of the processing can be improved.

Hereinafter, modifications of the embodiment described above will be described.

The medium conveyance path Ta described above is not limited to being parallel to the X-Y plane, and may have an angle with respect to the X-Y plane. Therefore, the movement direction of the line head 40 is not limited to being parallel to the Z-axis direction, and may have an angle with respect to the Z-axis direction.

In addition, the control unit 100 may include different encoders used for controlling the head movement motor 101 according to operations. For example, in the case of performing an origin detection operation, the head movement motor 101 may be controlled based on the output signal from the linear ENC 107. Then, after the origin detection operation is performed, the head movement motor 101 may be controlled based on the output signal from the rotary ENC 103.

In addition, the head movement motor 101 may be controlled based on the output signal from the linear ENC 107, and the control may be switched to the control using the rotary ENC 103 during the driving once the origin is detected due to a speed reduction. The switching of the target position, that is, the conversion from the linear ENC position to the rotary ENC position is also performed seamlessly during the driving, whereby deceleration, stop, and acceleration are not involved, and thus the throughput can be improved.

### Disposition of Protruding Portion

Next, the disposition of the protruding portion 55 will be described.

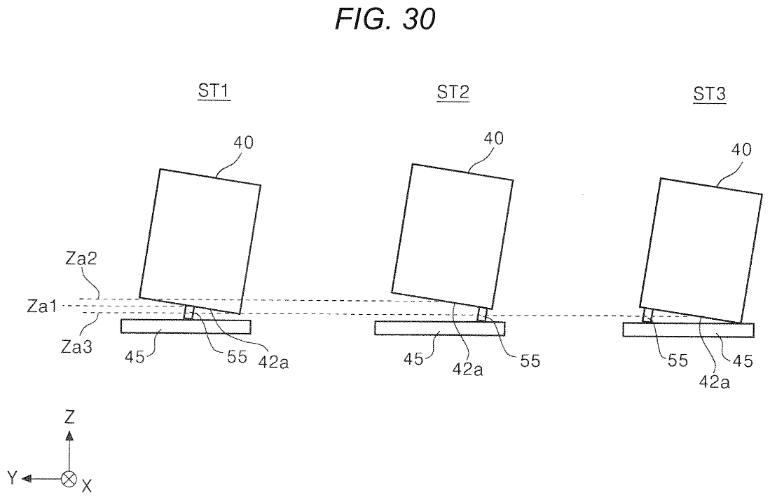

First, a problem associated with the disposition of the protruding portion 55 will be described with reference to FIG. 30. In FIG. 30, a form ST1 is an example in which the protruding portion 55 is provided in a central portion of the head surface 42a in the medium conveyance direction. In addition, a form ST2 is an example in which the protruding portion 55 is provided at the downstream end of the head surface 42a in the medium conveyance direction. In addition, a form ST3 is an example in which the protruding portion 55 is provided at the upstream end of the head surface 42a in the medium conveyance direction. In each form, as an example, the line head 40 is inclined such that an end portion of the head surface 42a in the +Y direction rises up.

As described above, the control unit 100 sets the origin position of the line head 40 based on the signal change of the rotary ENC 103. Then, based on this origin position, each drive region is set as shown in FIG. 24.

For example, a raised amount of the line head 40 in raising the line head 40 from the origin position to the first head position is d×1a [mm]. The control unit 100 raises the line head 40 by d×1a [mm] in order to raise the line head 40 from the origin position to the first head position.

Here, when the protruding portion 55 comes into contact with the facing portion 45, the line head 40 may be in a posture of being inclined as shown in FIG. 30. This is due to part accuracy and backlash between the guide frame 33 and the rack member 32 (see FIG. 7).

In the example in FIG. 30, when the protruding portion 55 is provided at the downstream end in the medium conveyance direction as shown in the form ST2, the head surface 42a is at a position far from the facing portion 45 as a whole. A position Za2 is a height position at a center position of the head surface 42a in the medium conveyance direction. Therefore, when the control unit 100 raises the line head 40 by d×1a [mm] from this state, the platen gap is larger than an appropriate value.

In addition, in the example in FIG. 30, when the protruding portion 55 is provided at the upstream end in the medium conveyance direction as shown in the form ST3, the head surface 42a as a whole approaches the facing portion 45. A position Za3 is a height position at the center position of the head surface 42a in the medium conveyance direction. Therefore, when the control unit 100 raises the line head 40 by d×1a [mm] from this state, the platen gap is smaller than the appropriate value. In this manner, in the forms ST2 and ST3, the height of the line head 40 when the protruding portion 55 comes into contact with the facing portion 45, more specifically, the height of the head surface 42a is inappropriate.

Note that, when the protruding portion 55 is provided at the center portion in the medium conveyance direction as shown in the form ST1, the height position at the center position of the head surface 42a is a position between the position Za2 and the position Za3 as indicated by reference numeral Za1. When the control unit 100 raises the line head 40 by d×1a [mm] from this state, the platen gap is in an appropriate range.

In this manner, in the configuration in which the position of the line head 40 in the movement direction when the protruding portion 55 comes into contact with the facing portion 45 is set as the origin position of the line head 40, there is a concern that the platen gap cannot be appropriately set depending on the position of the protruding portion 55.

Note that, FIG. 30 shows an example in which the end portion of the head surface 42a in the +Y direction is inclined so as to rise up, but similarly, when an end portion of the head surface 42a in the −Y direction is inclined so as to rise up, the platen gap is inappropriate in the case where the protruding portion 55 is provided at the upstream end and in the case where the protruding portion 55 is provided at the downstream end of the line head 40.

In view of the above problems, in the embodiment, the protruding portion 55 is disposed as follows.

As shown in FIG. 2, the plurality of protruding portions 55 are provided, and the plurality of protruding portions 55 include the first protruding portion 55A and the second protruding portion 55B.

Here, a position where the line head 40 performs recording on the most upstream in the conveyance direction is defined as a first recording position Y1, a position where the line head 40 performs recording on the most downstream in the conveyance direction is defined as a second recording position Y2, and an intermediate position between the first recording position Y1 and the second recording position Y2 is defined as a first intermediate position Yc1. The first recording position Y1 is a position of the most upstream nozzle 44 in the conveyance direction, and the second recording position Y2 is a position of the most downstream nozzle 44 in the conveyance direction.

In addition, a position where the line head 40 performs recording at the endmost portion in the +X direction in the medium width direction is defined as a third recording position X3. The +X direction is an example of a first intersecting direction. In addition, a position where the line head 40 performs recording at the endmost portion in the −X direction is defined as a fourth recording position X4. The −X direction is an example of a second intersecting direction. In addition, an intermediate position between the third recording position X3 and the fourth recording position X4 is defined as a second intermediate position Xc2. The third recording position X3 is a position of the nozzle 44 at the endmost portion in the +X direction, and the fourth recording position X4 is a position of the nozzle 44 at the endmost portion in the −X direction.

As shown in FIG. 2, in the conveyance direction, one of the first protruding portion 55A and the second protruding portion 55B is disposed upstream and the other is disposed downstream with respect to the first intermediate position Yc1. Specifically, the first protruding portion 55A is disposed upstream with respect to the first intermediate position Yc1 in the conveyance direction, and the second protruding portion 55B is disposed downstream with respect to the second intermediate position Xc2 in the conveyance direction.

In addition, one of the first protruding portion 55A and the second protruding portion 55B is disposed in the first intersecting direction with respect to the second intermediate position Xc2 and the other is disposed in the second intersecting direction with respect to the second intermediate position Xc2 such that one is disposed on the first intersecting direction of the second intermediate position and the other is disposed on the second intersecting direction in the medium width direction. Specifically, the second protruding portion 55B is disposed in the +X direction and the first protruding portion 55A is disposed in the −X direction with respect to the second intermediate position Xc2 in the medium width direction.

Accordingly, the height of the line head 40, more specifically, the height of the head surface 42a, when the first protruding portion 55A and the second protruding portion 55B come into contact with the facing portion 45 can be prevented from being inappropriate, and thus the platen gap can be appropriately set.

More specifically, in the embodiment, at the position of the first protruding portion 55A, the posture of the line head 40 is as shown in the mode ST3 in FIG. 30. In addition, at the position of the second protruding portion 55B, the posture of the line head 40 is as shown in the mode ST2 in FIG. 30. In addition, at the intermediate position between the first protruding portion 55A and the second protruding portion 55B in the medium width direction, the posture of the line head 40 is as shown in the mode ST1 in FIG. 30. That is, the head surface 42a is in a state of being inclined with respect to the X-axis direction.

However, in raising the line head 40 from this state, the cam 66 (see FIG. 8) presses up the contact portion 32a at an end portion in the +X direction and the contact portion 32a at an end portion in the −X direction, and thus the state where the head surface 42a is inclined with respect to the X-axis direction is released. Accordingly, the height position of the head surface 42a is appropriate as in the form ST1 shown in FIG. 30.

Note that, in FIG. 2, the first protruding portion 55A may be disposed downstream with respect to the first intermediate position Yc1, and the second protruding portion 55B may be disposed upstream with respect to the first intermediate position Yc1.

In addition, a distance between the third recording position X3 or the fourth recording position X4 and the second intermediate position Xc2 in the medium width direction is defined as a first distance Lx1. In the embodiment, the first protruding portion 55A and the second protruding portion 55B are at a position away from the second intermediate position Xc2 by ½ or more of the first distance Lx1. According to such a configuration, the posture of the line head 40 when the first protruding portion 55A and the second protruding portion 55B come into contact with the facing portion 45 is stabilized more reliably in the width direction, and the platen gap can be appropriately set.

Note that, a position Xd1 is a position away from the second intermediate position Xc2 by ½ of the first distance Lx1 in the +X direction, in other words, it is an intermediate position between the second intermediate position Xc2 and the third recording position X3. The second protruding portion 55B is preferably disposed in the +X direction with respect to the position Xd1.

In addition, a position Xd2 is a position separated from the second intermediate position Xc2 by the first distance Lx1 of ½ in the −X direction, in other words, it is an intermediate position between the second intermediate position Xc2 and the fourth recording position X4. The first protruding portion 55A is preferably disposed in the −X direction with respect to the position Xd2.

Note that, in the embodiment, the first protruding portion 55A is disposed further in the −X direction than the fourth recording position X4, and the second protruding portion 55B is disposed further in the +X direction than the third recording position X3. Accordingly, the posture of the line head 40 is further stabilized.

Note that, a distance between the second intermediate position Xc2 and the first protruding portion 55A and a distance between the second intermediate position Xc2 and the second protruding portion 55B in the medium width direction may be different from each other, but are preferably equal to each other. In the embodiment, the distance between the second intermediate position Xc2 and the first protruding portion 55A is equal to the distance between the second intermediate position Xc2 and the second protruding portion 55B in the medium width direction.

Note that, at least a part of the first protruding portion 55A and at least a part of the second protruding portion 55B may be within the region of the head surface 42a in the medium width direction. Accordingly, the first protruding portion 55A and the second protruding portion 55B come into contact with the facing portion 45 at a position close to the head surface 42a, and the platen gap can be appropriately set.

In addition, a distance between the first intermediate position Yc1 and the first protruding portion 55A and a distance between the first intermediate position Yc1 and the second protruding portion 55B in the medium conveyance direction may be different from each other, but are preferably equal to each other. In the embodiment, the distance between the first intermediate position Yc1 and the first protruding portion 55A is equal to the distance between the first intermediate position Yc1 and the second protruding portion 55B in the medium conveyance direction.

In addition, in the medium conveyance direction, the first protruding portion 55A and the second protruding portion 55B may be between the first recording position Y1 and the second recording position Y2, or may be deviated from a position between the first recording position Y1 and the second recording position Y2. In the embodiment, the first protruding portion 55A and the second protruding portion 55B are outside the position between the first recording position Y1 and the second recording position Y2.

In addition, in the embodiment, it is preferable that the first protruding portion 55A and the second protruding portion 55B are at positions where a maintenance unit does not interfere with when the maintenance unit performs maintenance on the line head 40. Accordingly, the maintenance unit can appropriately perform the maintenance on the line head 40.

In the embodiment, the first protruding portion 55A and the second protruding portion 55B are at positions where the maintenance unit is not interfered with when the maintenance unit performs maintenance on the line head 40. The cap portion 61 described above is an example of the maintenance unit.

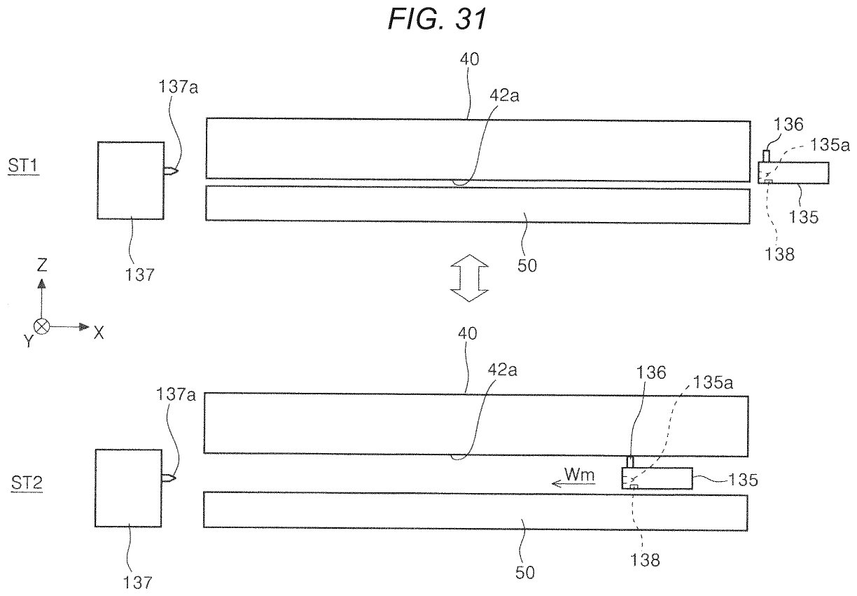

In addition, a wiper 136 shown in FIG. 31 is an example of the maintenance unit. Here, the wiper 136 will be described with reference to FIG. 31.

As shown in FIG. 31, the printer 1 includes a wiper carriage 135, which is moved in the X-axis direction by a motor (not shown). In the embodiment, an end portion position of the wiper carriage 135 in the +X direction is a home position.

The wiper carriage 135 is formed in a box shape having an open upper side, and is provided with the wiper 136. The wiper 136 is made of an elastic material such as rubber, and particularly wipes the head chip 43 (see FIG. 2) on the head surface 42a when the wiper carriage 135 in a state of being elastic contact with the head surface 42a is moved in the medium width direction. The ink removed by the wiping is accumulated in the wiper carriage 135.

A fitting hole 135a is provided in an end portion of the wiper carriage 135 in the −X direction. A check valve (not shown) is provided in the fitting hole 135a, and prevents the ink accumulated in the wiper carriage 135 from leaking.

An ink collection portion 137 is provided on an end portion of a movement region of the wiper carriage 135 in the −X direction. The ink collection portion 137 includes a suction portion 137a, and the suction portion 137a can be fitted into the fitting hole 135a of the wiper carriage 135. When the wiper carriage 135 is moved to the end portion in the −X direction, the suction portion 137a is fitted into the fitting hole 135a. When the suction portion 137a is fitted into the fitting hole 135a, the check valve is open. In this state, a pump (not shown) provided in the ink collection portion 137 is driven to drawn the ink accumulated in the wiper carriage 135.

A state ST1 in FIG. 31 shows a state where the line head 40 is at a recording position. In the case of wiping the head surface 42a by the wiper 136 from this state, the line head 40 is raised to a retract position as shown by a change from the state ST1 to a state ST2 in FIG. 31. Accordingly, a gap into which the wiper carriage 135 enters is formed between the line head 40 and the facing portion 45, and the wiper 136 can come into contact with the head surface 42a.

In this state, the wiper carriage 135 is moved as indicated by an arrow Wm to cause the wiper 136 to wipe the head surface 42a.

Note that, after the wiper 136 is moved to the end portion in the −X direction, that is, after the wiper 136 wipes the head surface 42a, the wiper carriage 135 is moved in the +X direction to return to the home position at the end portion in the +X direction. Prior to this movement, the line head 40 may be slightly raised to prevent the wiper 136 from coming into contact with the head surface 42a.

As described above, since the wiper 136 wipes the head surface 42a, it is preferable that the first protruding portion 55A and the second protruding portion 55B are at positions where the wiper 136 is not interfered with when the wiper 136 performs the maintenance on the line head 40.

However, depending on the movement region of the wiper 136, it is not necessary to dispose both the first protruding portion 55A and the second protruding portion 55B at positions where the wiper 136 is not interfered with, and only one of the first protruding portion 55A and the second protruding portion 55B may be disposed at the position where the wiper 136 is not interfered with. For example, in FIG. 2, the first protruding portion 55A is between the first recording position Y1 and the second recording position Y2 in the conveyance direction, and only the second protruding portion 55B is at the position where the wiper 136 is not interfered with. In this case, when the wiper 136 moves toward the end portion in the −X direction, if the wiper 136 returns in the +X direction before coming into contact with the first protruding portion 55A, the wiper 136 does not interfere with the first protruding portion 55A.

In the above embodiment, one of the first protruding portion 55A and the second protruding portion 55B is disposed upstream and the other is disposed downstream with respect to the first intermediate position Yc1 in the conveyance direction, but instead, the first protruding portion 55A and the second protruding portion 55B may be disposed at the first intermediate position Yc1 in the conveyance direction. Note that, in this case, the first protruding portion 55A and the second protruding portion 55B are disposed such that the second intermediate position Xc2 is interposed therebetween in the medium width direction as in the embodiment described above.

Accordingly, the posture of the line head 40 when the first protruding portion 55A and the second protruding portion 55B come into contact with the facing portion 45 is as in the form ST1 shown in FIG. 30, and the height of the head surface 42a can be prevented from being inappropriate, and thus the platen gap can be appropriately set.

Note that, in the case of disposing the first protruding portion 55A and the second protruding portion 55B at the first intermediate position Yc1 in the conveyance direction, the first protruding portion 55A and the second protruding portion 55B do not need to be strictly disposed at the first intermediate position Yc1, and may be slightly displaced from the first intermediate position Yc1, for example, may be displaced within 5 mm.

Hereinafter, features of the above embodiment will be further described.

In the embodiment, the linear ENC 107 detects the position of the line head 40 between the first protruding portion 55A and the second protruding portion 55B in the medium width direction. This is clear from the position of the linear ENC 107 shown in FIG. 10. Accordingly, when detecting the position of the line head 40, the position of the line head 40 can be appropriately detected without being influenced by the posture of the line head 40 in the medium width direction.

Note that, it is suitable that the linear ENC 107 detects the position of the line head 40 at a position away from the second intermediate position Xc2 by less than ½ of the first distance in the medium width direction. That is, it is suitable that the linear scale 108 detects the position of the line head 40 between the position Xd1 and the position Xd2 in FIG. 2. Accordingly, when detecting the position of the line head 40, the position of the line head 40 is less likely to be influenced by the posture of the line head 40 in the width direction, and the position of the line head 40 can be more appropriately detected.

In particular, the linear scale 108 constituting the linear ENC 107 in the embodiment is at a position overlapping the second intermediate position Xc2 shown in FIG. 2 in the medium width direction. Accordingly, the position of the line head 40 can be more appropriately detected.

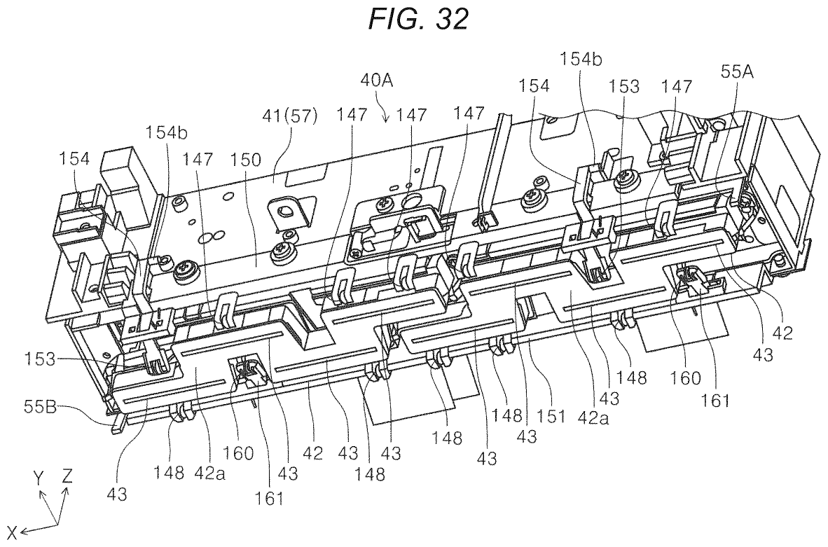

Next, a line head and a protruding portion according to another embodiment will be described with reference to FIG. 32 and subsequent drawings.

In the embodiment, a line head 40A includes two plate members 42 along a medium width direction. In each of the plate members 42, the head chips 43 are alternately disposed at an upstream position and a downstream position along an X-axis direction, that is, the medium width direction. In each of the plate members 42, two head chips 43 are provided at the upstream position along the medium width direction, and two head chips 43 are provided at the downstream position along the medium width direction. Accordingly, in the line head 40A, four head chips 43 are provided at the upstream position along the medium width direction, and four head chips 43 are provided at the downstream position along the medium width direction.

An escape portion is formed between two head chips 43 adjacent to each other in the medium width direction.

Here, a front end and a rear end of a medium passing between the line head 40A and the facing portion 45, particularly end portions in the medium width direction, sometimes curl and rise up and come into contact with the head surface 42a, causing the medium to be contaminated. Therefore, it is suitable that the line head 40A is provided with a contact roller that comes into contact with the medium to prevent the medium from contacting from the head surface 42a.

In the embodiment, as such a contact roller, an upstream fixed roller 147, a downstream fixed roller 148, an upstream movable roller 153, and a downstream movable roller 160 are provided. These rollers are each a toothed roller having teeth at an outer circumference, and can therefore prevent the ink from adhering thereto and from then adhering to the medium.

Note that, hereinafter, the upstream movable roller 153 and the downstream movable roller 160 may be collectively referred to as a movable roller. Hereinafter, the upstream fixed roller 147 and the downstream fixed roller 148 may be collectively referred to as a fixed roller.

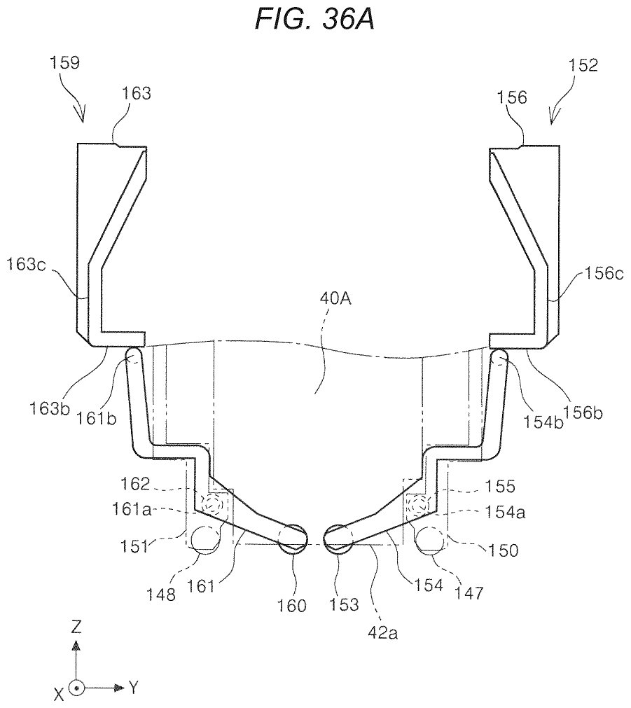

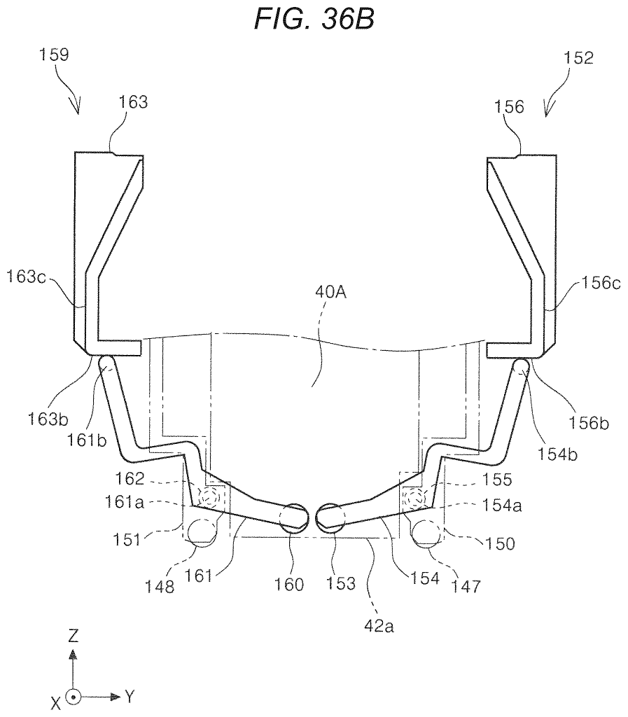

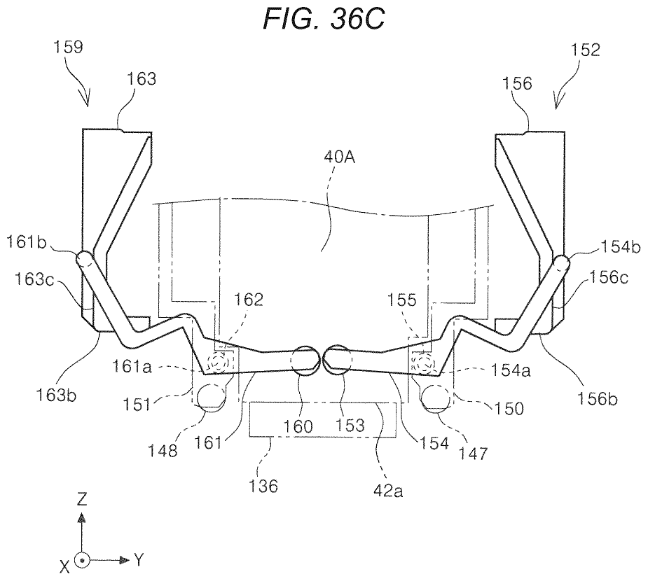

The fixed roller protrudes from the head surface 42a in a −Z direction, that is, toward the facing portion 45 as shown in FIGS. 36A to 36C regardless of a position of the line head 40A. Accordingly, the fixed roller prevents the contact between the medium and the head surface 42a.

As shown in FIG. 32, the line head 40A includes an upstream frame 150 on a side surface thereof at an upstream in the medium conveyance direction, that is, in a +Y direction, and includes a downstream frame 151 on a side surface thereof at a downstream in the medium conveyance direction, that is, in a −Y direction.

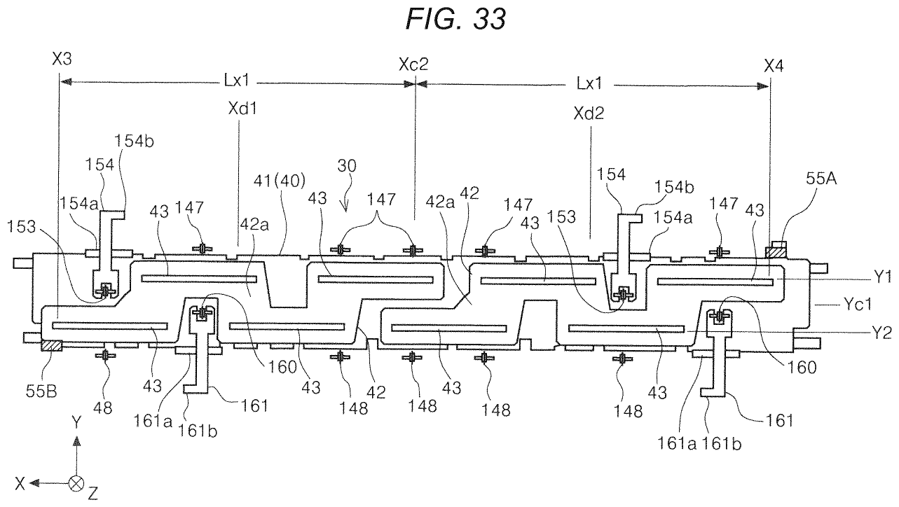

The upstream fixed roller 147 is rotatably supported by the upstream frame 150. A plurality of upstream fixed rollers 147 are provided in the upstream frame 150 along the medium width direction. In addition, the upstream fixed roller 147 is at a position upstream of the plate member 42 in the medium conveyance direction, that is, in the +Y direction, as shown in FIG. 33. The upstream frame 150 is an example of the holding member that holds the upstream fixed roller 147. Note that, FIG. 33 does not show the upstream frame 150 or the downstream frame 151 for convenience of illustration.

As shown in FIG. 32, the downstream fixed roller 148 is rotatably supported by the downstream frame 151. A plurality of downstream fixed rollers 148 are provided in the downstream frame 151 along the medium width direction. In addition, the downstream fixed roller 148 is at a position downstream of the plate member 42 in the medium conveyance direction, that is, in the −Y direction, as shown in FIG. 33. The downstream frame 151 is an example of the holding member that holds the downstream fixed roller 148.

Next, the movable roller can be displaced to a first position and a second position which are relative positions with respect to the head surface 42a. FIG. 36A shows the first position of the movable roller. The first position is a position where the movable roller can interfere with the wiper 136 and can come into contact with the medium. In other words, the first position of the movable roller is a position which is inside a trajectory along which the wiper 136, for wiping the head surface 42a, moves and where the movable roller can come into contact with the medium. In the embodiment, the first position of the movable roller is a position where the movable roller protrudes from the head surface 42a in the −Z direction.

The second position of the movable roller is a position where the wiper 136 is not interfered with. Specifically, the second position of the movable roller is a position where the movable roller is retracted from the head surface 42a in a +Z direction. FIG. 36C shows the second position of the movable roller.

When the movable roller is at the first position in this manner, the contact between the medium and the head surface 42a can be prevented. When the movable roller is at the second position, the movable roller can be prevented from hindering the wiper 136 in wiping the head surface 42a. Therefore, it is not necessary to dispose a plurality of wipers 136 to avoid the movable roller, and an increase in cost of the printer 1 can be prevented. In addition, in the case of replacing the wiper 136, the number of work steps and the cost of parts can be prevented from increasing remarkably.

Next, a displacement mechanism that displaces the movable roller to the first position and the second position will be described primarily with reference to FIGS. 36A to 36C. Note that, FIGS. 36A to 36C primarily show, for convenience of illustration, configurations of an upstream displacement mechanism 152 and a downstream displacement mechanism 159 indicated by solid lines, and other configurations indicated by a two-dot chain line.

In the embodiment, the upstream displacement mechanism 152, which displaces the upstream movable roller 153, and the downstream displacement mechanism 159, which displaces the downstream movable roller 160, are provided as the displacement mechanism that displaces the movable roller to the first position and the second position.

The upstream displacement mechanism 152 and the downstream displacement mechanism 159 have the same basic configuration, and the upstream displacement mechanism 152 and the downstream displacement mechanism 159 form a bilaterally symmetrical structure when viewed in the medium width direction, as shown in FIGS. 36A to 36C.

The upstream displacement mechanism 152 includes an upstream support member 154 and an upstream cam member 156. The upstream support member 154 is a member that rotatably supports the upstream movable roller 153, and can pivot around a pivot shaft 154a to change a posture to a first pivot posture (FIG. 36A) in which the upstream movable roller 153 is at the first position and a second pivot posture (FIG. 36C) in which the upstream movable roller 153 is at the second position. The upstream support member 154 is an example of the holding member that holds the upstream movable roller 153. In the embodiment, a shaft center line of the pivot shaft 154a is parallel to the X-axis direction. The pivot shaft 154a is supported by the upstream frame 150 (see FIG. 32).

In addition, the upstream support member 154 is pressed by a coil spring 155 as a pressing member in a counterclockwise direction in FIGS. 36A to 36C, that is, in a direction in which the upstream movable roller 153 moves toward the first position. Note that, a pressing force from the coil spring 155 may be adjusted, and the upstream movable roller 153 may be retracted when the upstream movable roller 153 comes into contact with a medium having high stiffness such as thick paper. Accordingly, contact between a medium having low stiffness and the head surface 42a can be prevented, and the occurrence of a jam or damage to the medium due to the contact between the medium having high stiffness and the upstream movable roller 153 can be prevented.

Note that, when the upstream support member 154 can return from the second pivot posture to the first pivot posture by its own weight, the coil spring 155 may be omitted.

In addition, the upstream support member 154 includes a cam follower 154b as a portion engageable with the upstream cam member 156.

The upstream cam member 156 is a member provided independently of the line head 40A and is engageable with the upstream support member 154. The upstream cam member 156 is provided in a frame (not shown). The upstream support member 154 is movable relative to the upstream cam member 156 in a Z-axis direction along with the raising and lowering operations of the line head 40A.

The upstream cam member 156 has a horizontal cam surface 156b along an X-Y plane and a vertical cam surface 156c along an X-Z plane.

The downstream displacement mechanism 159 includes a downstream support member 161 and a downstream cam member 163. The downstream support member 161 is a member that rotatably supports the downstream movable roller 160, and can pivot around a pivot shaft 161a to change a posture to a first pivot posture (FIG. 36A) in which the downstream movable roller 160 is at the first position and a second pivot posture (FIG. 36C) in which the downstream movable roller 160 is at the second position. The downstream support member 161 is an example of the holding member that holds the downstream movable roller 160. In the embodiment, a shaft center line of the pivot shaft 161a is parallel to the X-axis direction. The pivot shaft 161a is supported by the downstream frame 151 (see FIG. 32).

In addition, the downstream support member 161 is pressed by a coil spring 162 as a pressing member in a clockwise direction in FIGS. 36A to 36C, that is, in a direction in which the downstream movable roller 160 moves toward the first position.

Note that, a pressing force from the coil spring 162 may be adjusted, and the downstream movable roller 160 may be retracted when the downstream movable roller 160 comes into contact with a medium having high stiffness such as thick paper. Accordingly, contact between a medium having low stiffness and the head surface 42a can be prevented, and the occurrence of a jam or damage to the medium due to the contact between the medium having high stiffness and the downstream movable roller 160 can be prevented.

Note that, when the downstream support member 161 can return from the second pivot posture to the first pivot posture by its own weight, the coil spring 162 may be omitted.

In addition, the downstream support member 161 includes a cam follower 161b as a portion engageable with the downstream cam member 163.

The downstream cam member 163 is a member provided independently of the line head 40A and is engageable with the downstream support member 161. The downstream cam member 163 is provided in a frame (not shown). The downstream support member 161 is movable relative to the downstream cam member 163 in the Z-axis direction along with the raising and lowering operations of the line head 40A.

The downstream cam member 163 has a horizontal cam surface 163b along the X-Y plane and a vertical cam surface 163c along the X-Z plane.

FIG. 36A shows a state where the line head 40A is at the recording position, the movable rollers are at the first position, and the upstream support member 154 and the downstream support member 161 are in the first pivot posture. In the case of wiping the head surface 42a by the wiper 136 (see FIG. 31) from this state, the line head 40A is raised toward the retract position. As the line head 40A is raised, the horizontal cam surface 156b guides the upstream support member 154 toward the second pivot posture, and the horizontal cam surface 163b guides the downstream support member 161 toward the second pivot posture, as shown in a change from FIG. 36A to FIG. 36B.

When the line head 40A is further raised, the cam follower 154b of the upstream support member 154 transitions from the horizontal cam surface 156b to the vertical cam surface 156c, and the line head 40A is raised in a state where the upstream support member 154 is maintained in the second pivot posture, as shown in FIG. 36C.

Similarly, the cam follower 161b of the downstream support member 161 transitions from the horizontal cam surface 163b to the vertical cam surface 163c, and the line head 40A is raised in a state where the downstream support member 161 is maintained in the second pivot posture.

When the line head 40A moves to the retract position shown in FIG. 36C, since the movable rollers retract from the head surface 42a, the wiper 136 can wipe the head surface 42a.

As described above, since the upstream cam member 156 has the vertical cam surface 156c for maintaining the posture of the upstream support member 154 in addition to the horizontal cam surface 156b for changing the posture of the upstream support member 154, a pivot amount of the upstream support member 154 can be minimized. That is, since a raised amount of the upstream movable roller 153 can be minimized, a space for receiving the upstream movable roller 153 in the line head 40A can be minimized, and an increase in size of the line head 40A can be prevented.

Similarly, since the downstream cam member 163 has the vertical cam surface 163c for maintaining the posture of the downstream support member 161 in addition to the horizontal cam surface 163b for changing the posture of the downstream support member 161, a pivot amount of the downstream support member 161 can be minimized. That is, since a raised amount of the downstream movable roller 160 can be minimized, a space for receiving the downstream movable roller 160 in the line head 40A can be minimized, and an increase in size of the line head 40A can be prevented.

Note that, when the line head 40A is lowered toward the recording position from the state shown in FIG. 36C, the state of the line head 40A changes so as to reverse to the manner described above, the upstream cam member 156 guides the upstream support member 154 from the second pivot posture to the first pivot posture, and the downstream cam member 163 guides the downstream support member 161 from the second pivot posture to the first pivot posture. Accordingly, the upstream movable roller 153 and the downstream movable roller 160 are displaced from the second position to the first position.

As described above, the movable rollers can be displaced in conjunction with a displacement operation of the line head 40A in a simple configuration including the upstream support member 154, the upstream cam member 156, the downstream support member 161, and the downstream cam member 163.

In addition, as described above, the displacement mechanism that displaces the movable roller, that is, the upstream displacement mechanism 152 and the downstream displacement mechanism 159 convert the displacement operation of the line head 40A into the displacement operation of the movable roller. In addition, the displacement mechanism displaces the movable roller from the first position to the second position when the line head 40A is displaced from the recording position to the retract position, and displaces the movable roller from the second position to the first position when the line head 40A is displaced from the retract position to the recording position. Accordingly, a power source for displacing the movable roller is not required, and an increase in cost of the printer 1 can be prevented.

In addition, in the embodiment, the movable roller is displaced to the first position and the second position when moved in a direction intersecting the head surface 42a. Accordingly, an increase in size of the line head 40A in the medium conveyance direction can be prevented as compared with a configuration in which the movable roller is moved along the medium conveyance direction.

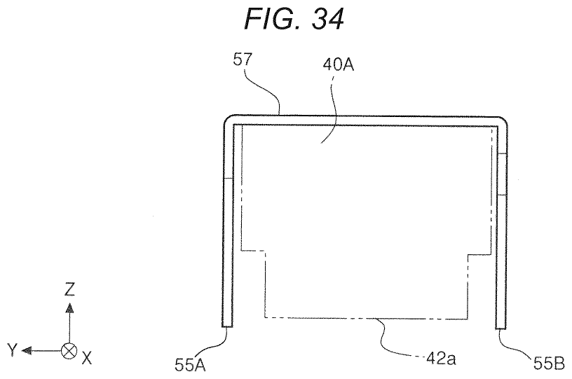

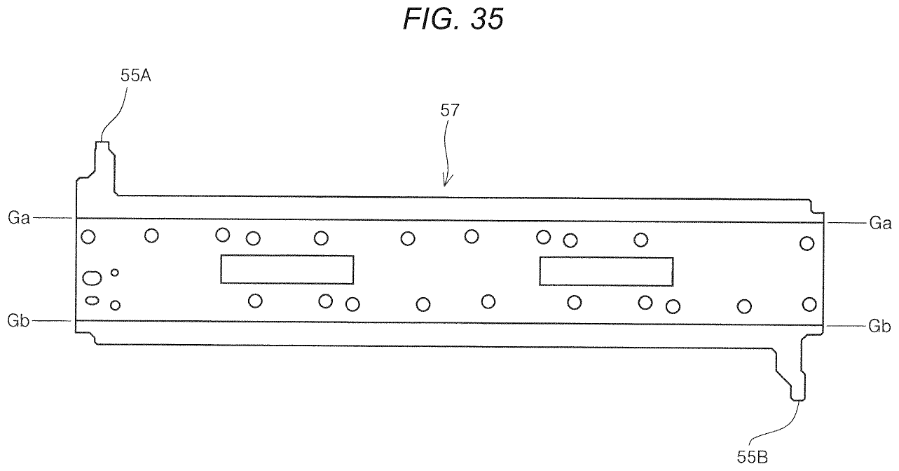

In the line head 40A having the above configuration, the first protruding portion 55A and the second protruding portion 55B can be provided in a head frame 57 (see FIG. 32) constituting the base 41. As an example, the head frame 57 can be formed by bending a metal plate material. FIG. 35 is a plan view of the head frame 57 before bending, and the first protruding portion 55A and the second protruding portion 55B are formed so as to protrude in opposite directions in a state before bending. By bending the head frame 57 at a line Ga-Ga and a line Gb-Gb, as shown in FIG. 34, the first protruding portion 55A and the second protruding portion 55B can be formed to protrude in the −Z direction. According to such a configuration, the first protruding portion 55A and the second protruding portion 55B can be easily formed.

Note that, such a configuration may be applied to the line head 40 described above.

In addition as described above, in the configuration including the contact roller (153, 160, 147, 148) and the holding member (150, 151, 154, 161) that holds the contact roller, the first protruding portion 55A and the second protruding portion 55B can be provided on the holding member. In this case, a dedicated member for providing the first protruding portion 55A and the second protruding portion 55B is not required, and an increase in cost of the printer 1 can be prevented.

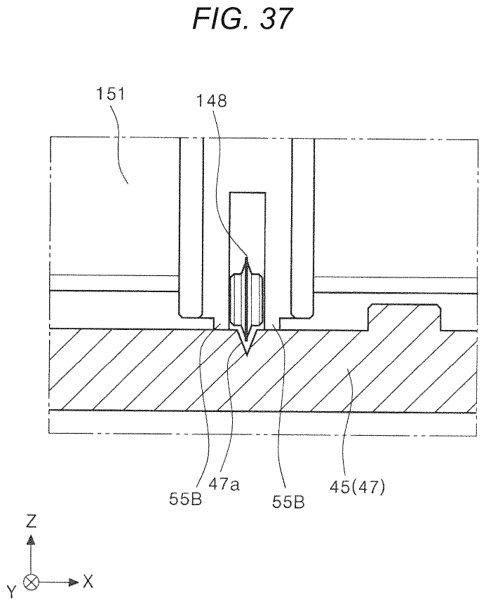

FIG. 37 is an example in which the second protruding portion 55B is provided in the downstream frame 151. The second protruding portion 55B protrudes from the downstream fixed roller 148 to the shutter 47, that is, the facing portion 45, and a recessed portion 47a is formed in the shutter 47. Accordingly, when the second protruding portion 55B comes into contact with the shutter 47, that is, the facing portion 45, the downstream fixed roller 148 can be prevented from coming into contact with the shutter 47, that is, the facing portion 45, as shown in FIG. 37.

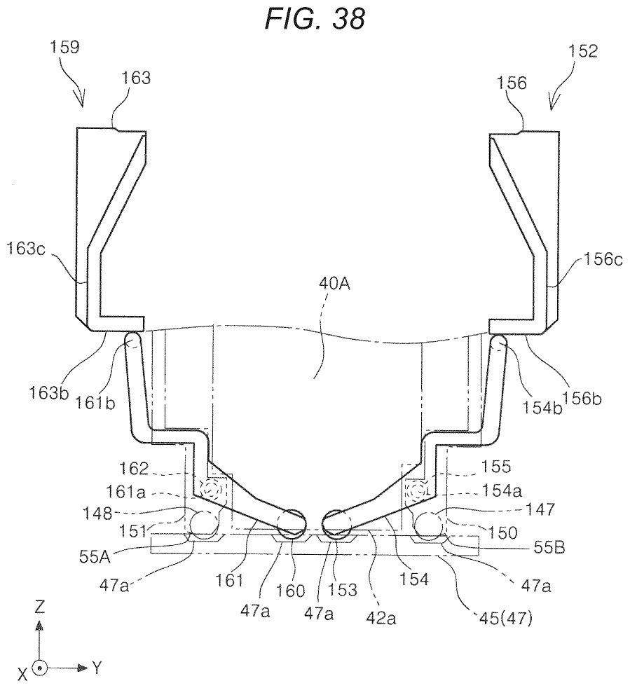

Note that, as shown in FIG. 38, the upstream frame 150 may also be provided with the first protruding portion 55A, and in this case, it is suitable to provide the shutter 47 with a recessed portion 47a for avoiding the upstream fixed roller 147. Similarly, it is also suitable to provide the shutter 47 with a recessed portion 47a for avoiding the upstream movable roller 153 and the downstream movable roller 160.

In addition, it is also suitable that one or both of the first protruding portion 55A and the second protruding portion 55B can be moved to a position where the maintenance unit is not interfered with when the maintenance unit performs the maintenance on the line head 40.

Such a configuration can be implemented by, as an example, one or both of providing the first protruding portion 55A on the upstream support member 154 and providing the second protruding portion 55B on the downstream support member 161.

For example, in the case of wiping the head surface 42a by the wiper 136 as the maintenance unit, as shown in FIG. 36C, the upstream support member 154 and the downstream support member 161 retract above the head surface 42a, that is, move to a position where the wiper 136 is not interfered with. According to such a configuration, the maintenance unit can appropriately perform the maintenance on the line head 40.

Further, the present disclosure is not limited to the embodiments and modifications described above and various modifications can be made within the scope of the disclosure set forth in the appended claims, and it is needless to say that these modifications also fall within the scope of the present disclosure.

What is claimed is:

1. A recording apparatus comprising:
a conveyance path configured to convey a medium in a conveyance direction;
a recording unit configured to perform recording on the medium, the recording unit being movable in a direction advancing and retracting with respect to the conveyance path;
a facing portion disposed to face the recording unit;
a plurality of protruding portions provided in a portion where the recording unit is provided and protruding toward the facing portion;
a motor as a power source when moving the recording unit;
a moving unit configured to move the recording unit by receiving power from the motor; and
a control unit configured to set, as an origin position of the recording unit, a position in a movement direction of the recording unit when the protruding portion is in contact with the facing portion, wherein
the plurality of protruding portions include a first protruding portion and a second protruding portion,
a position where the recording unit performs recording at most upstream in the conveyance direction is defined as a first recording position, a position where the recording unit performs recording on a most downstream in the conveyance direction is defined as a second recording position, and an intermediate position between the first recording position and the second recording position is defined as a first intermediate position,
a position where the recording unit performs recording at an endmost portion in a first intersecting direction that is a direction intersecting the conveyance direction is defined as a third recording position, a position where the recording unit performs recording at an endmost portion in a second intersecting direction that is a direction opposite to the first intersecting direction is defined as a fourth recording position, and an intermediate position between the third recording position and the fourth recording position is defined as a second intermediate position,
one of the first protruding portion and the second protruding portion is disposed upstream and the other is disposed downstream with respect to the first intermediate position in the conveyance direction, and
one of the first protruding portion and the second protruding portion is disposed in the first intersecting direction with respect to the second intermediate position and the other is disposed in the second intersecting direction with respect to the second intermediate position such that one is disposed on the first intersecting direction of the second intermediate position and the other is disposed on the second intersecting direction in a width direction including the first intersecting direction and the second intersecting direction.

2. A recording apparatus comprising:
a conveyance path configured to convey a medium in a conveyance direction;
a recording unit configured to perform recording on the medium, the recording unit being movable in a direction advancing and retracting with respect to the conveyance path;
a facing portion disposed to face the recording unit;
a plurality of protruding portions provided in a portion where the recording unit is provided and protruding toward the facing portion;
a motor as a power source when moving the recording unit;
a moving unit configured to move the recording unit by receiving power from the motor; and
a control unit configured to set, as an origin position of the recording unit, a position in a movement direction of the recording unit when the protruding portion is in contact with the facing portion, wherein
the plurality of protruding portions include a first protruding portion and a second protruding portion,
a position where the recording unit performs recording at most upstream in the conveyance direction is defined as a first recording position, a position where the recording unit performs recording on a most downstream in the conveyance direction is defined as a second recording position, and an intermediate position between the first recording position and the second recording position is defined as a first intermediate position,
a position where the recording unit performs recording at an endmost portion in a first intersecting direction that is a direction intersecting the conveyance direction is defined as a third recording position, a position where the recording unit performs recording at an endmost portion in a second intersecting direction that is a direction opposite to the first intersecting direction is defined as a fourth recording position, and an intermediate position between the third recording position and the fourth recording position is defined as a second intermediate position,
the first protruding portion and the second protruding portion are disposed at the first intermediate position in the conveyance direction, and
one of the first protruding portion and the second protruding portion is disposed in the first intersecting direction with respect to the second intermediate position and the other is disposed in the second intersecting direction with respect to the second intermediate position such that one is disposed on the first intersecting direction of the second intermediate position and the other is disposed on the second intersecting direction in a width direction including the first intersecting direction and the second intersecting direction.

3. The recording apparatus according to claim 1, wherein
a distance between the third recording position or the fourth recording position and the second intermediate position in the width direction is defined as a first distance, and
the first protruding portion and the second protruding portion are at a position away from the second intermediate position by ½ or more of the first distance.

4. The recording apparatus according to claim 1, further comprising:
a maintenance unit configured to perform maintenance on the recording unit, wherein
the first protruding portion and the second protruding portion are at positions where the maintenance unit is not interfered with when the maintenance unit performs maintenance on the recording unit.

5. The recording apparatus according to claim 1, further comprising:
a maintenance unit configured to perform maintenance on the recording unit, wherein
at least one of the first protruding portion and the second protruding portion is movable to a position where the maintenance unit is not interfered with when the maintenance unit performs maintenance on the recording unit.

6. The recording apparatus according to claim 1, wherein
the recording unit has a head surface facing the facing portion, and
at least a part of the first protruding portion and at least a part of the second protruding portion are within a region of the head surface in the width direction.

7. The recording apparatus according to claim 1, wherein
the recording unit includes a head surface facing the facing portion, a contact roller protruding from the head surface to the facing portion and configured to prevent contact of the medium with the head surface, and a holding member configured to hold the contact roller, and
the first protruding portion and the second protruding portion are provided on the holding member.

8. The recording apparatus according to claim 1, further comprising:
a position detection unit configured to detect a position of the recording unit in the movement direction, wherein
the control unit sets the origin position based on that the recording unit has no position change based on the position detection unit during driving of the motor.

9. The recording apparatus according to claim 8, wherein
the position detection unit detects the position of the recording unit between the first protruding portion and the second protruding portion in the width direction.

10. The recording apparatus according to claim 9, wherein
a distance between the third recording position or the fourth recording position and the second intermediate position in the width direction is defined as a first distance, and
the position detection unit detects the position of the recording unit at a position away from the second intermediate position in the width direction by less than ½ of the first distance.

11. The recording apparatus according to claim 1, further comprising:
a position detection unit configured to detect a position of the recording unit in the movement direction; and
a rotation detection unit configured to detect rotation of the motor, wherein
the position detection unit is a linear encoder including a linear scale provided along the movement direction of the recording unit, and a first detection unit that is a detection unit provided in the recording unit and that detects the linear scale,
the rotation detection unit is a rotary encoder including a rotary scale that rotates with the rotation of the motor, and a second detection unit that detects the rotary scale,
the moving unit includes a speed reduction mechanism having a speed reduction ratio larger than 1 when the power is transmitted from the motor to the recording unit, and
the control unit grasps the position of the recording unit in the movement direction based on a signal from the linear encoder and controls the motor based on a signal from the rotary encoder.
